(19) United States
(12) Patent Application Publication
(10) Pub. No.: US 2026/0158435 A1
(43) Pub. Date: Jun. 11, 2026

(54) SCRUBBING APPARATUS

(71) Applicant: Seung Hwan OH, Seoul (KR)

(72) Inventor: Seung Hwan OH, Seoul (KR)

(21) Appl. No.: 19/204,764

(22) Filed: May 12, 2025

Related U.S. Application Data
(63) Continuation of application No. PCT/KR2024/011940, filed on Aug. 12, 2024.

(30) Foreign Application Priority Data
Jul. 10, 2024 (KR) 10-2024-0090918

(51) Int. Cl. B01D 53/18; B01D 53/14

(52) U.S. Cl. CPC B01D 53/18; B01D 53/1406

(57) ABSTRACT

The scrubbing apparatus of the present invention includes a first scrubber that primarily scrubs the gas and a second scrubber that secondarily scrubs the gas. The first scrubber includes: a first chamber; a first scrubbing plate that is fixed, at least in part, to an inner wall of the first chamber; a first solution supply nozzle that supplies a first scrubbing solution to an upper surface of the first scrubbing plate; and a plurality of first scrubbing holes that penetrate the first scrubbing plate. The second scrubber includes: a second; a second scrubbing plate that is disposed within the second chamber and fixed, at least in part, to an inner wall of the second chamber; a second solution supply nozzle that supplies a second scrubbing solution to an upper surface of the second scrubbing plate; and a plurality of second scrubbing holes that penetrate the second scrubbing plate.

### TECHNICAL FIELD

The present invention relates to a scrubbing apparatus. Specifically, the present

invention relates to a scrubbing apparatus that improves both scrubbing efficiency and spatial efficiency by utilizing a plurality of scrubbers.

### BACKGROUND ART

In modern industries, various types of air pollutants are generated, many of which have

extremely low permissible exposure limits for humans. Accordingly, removing air pollutants from gases emitted in various industrial fields before discharge is a critical issue.

Currently used air pollution prevention facilities include dust collectors and scrubbers, and they are installed considering their efficiency depending on the type of pollutant. Among these, scrubbers are widely used because they can simultaneously process dust, exhaust gas, and high-temperature gas.

Specifically, scrubbers are classified into dry, wet, and plasma types depending on the method of treating the exhaust gas, and wet scrubbers are used in a process that causes the exhaust gas to come into contact with a liquid to dissolve water-soluble components in the gas into the liquid.

In wet scrubbers, a scrubbing solution is generally used to effectively remove harmful components of the exhaust gas. When the scrubbing solution comes into contact with harmful components, it removes the harmful components through a chemical reaction such as neutralization, so the one that best reacts chemically with the harmful components of the emitted gas should be selected. The performance of the wet scrubber is determined by whether the solution containing the scrubbing solution can efficiently contact the exhaust gas. Therefore, in the past, a filler was installed so that the solution containing the scrubbing solution, and the exhaust gas could sufficiently come into contact, and a spray nozzle was installed to supply water with small particles.

Recently, a technology that can improve the contact area between the scrubbing solution and the exhaust gas has been studied.

### SUMMARY

### Technical Problem

The technical problems to be solved by the present invention are to provide a scrubbing

apparatus that enhances scrubbing efficiency by increasing the contact area between the scrubbing solution and the gas, and to provide the scrubbing apparatus that improves spatial efficiency by employing a plurality of scrubbers.

The problems that the present invention is trying to solve are not limited to the problems mentioned above, and other problems that are not mentioned can be clearly understood by those skilled in the art from the description below.

### Solution to Problem

A scrubbing apparatus according to some embodiments of the present invention for achieving the above technical problem comprises a first scrubber for performing primary scrubbing of gas, and a second scrubber connected to the first scrubber, for performing secondary scrubbing of the gas that has passed through the first scrubber, wherein the first scrubber comprising: a first chamber for defining a first scrubbing space for scrubbing a portion of impurities contained in the gas, a first scrubbing plate disposed in the first chamber, at least a portion of the first scrubbing plate being fixed to an inner side wall of the first chamber, a first solution supply nozzle for supplying a first scrubbing solution onto an upper surface of the first scrubbing plate, and a plurality of first scrubbing holes penetrating the first scrubbing plate, the second scrubber comprising: a second chamber for defining a second scrubbing space for scrubbing another portion of impurities contained the gas, a second scrubbing plate disposed in the second chamber, at least a portion of the second scrubbing plate being fixed to an inner side wall of the second chamber, a second solution supply nozzle for supplying a second scrubbing solution onto an upper surface of the second scrubbing plate, and a plurality of second scrubbing holes penetrating the second scrubbing plate.

In the scrubbing apparatus of the present invention, the first scrubber and the second scrubber are connected to each other. Since the gas is primarily scrubbed in the first scrubber and secondarily scrubbed in the second scrubber, scrubbing efficiency can be improved, and spatial efficiency can also be enhanced.

In some embodiments, wherein a portion of the impurities contained in the gas is dissolved in the first scrubbing solution by ascending through the plurality of first scrubbing holes within the first chamber, and wherein another portion of the impurities contained in the gas is dissolved in the second scrubbing solution by ascending through the plurality of second scrubbing holes within the second chamber.

As the gas ascends through the scrubbing holes and bubbles are generated in the scrubbing solution, the contact area between the gas and the scrubbing solution can be increased. Accordingly, the efficiency of the scrubbing process can be improved.

The scrubbing apparatus according to some embodiments further comprises a third scrubber connected to the second scrubber and scrubbing the gas that has passed through the second chamber, wherein the third scrubber comprises: a third chamber defining a third scrubbing space in which another portion of the impurities contained in the gas is scrubbed, a third scrubbing plate disposed in the third chamber and at least partially fixed to an inner side wall of the third chamber, a third solution supply nozzle that supplies a third scrubbing solution onto an upper surface of the third scrubbing plate, and a plurality of third scrubbing holes penetrating the third scrubbing plate, wherein the first scrubber, the second scrubber, and the third scrubber are arranged in series along the same direction.

The scrubbing apparatus according to some embodiments further comprises a fourth scrubber connected to the third scrubber, and scrubbing the gas that has passed through the third scrubber, wherein the first to fourth scrubbers are arranged in series along the same direction, or in an L-shaped configuration.

The scrubbing apparatus according to some embodiments further comprises a third scrubber connected to the second scrubber and scrubbing the gas that has passed through the second chamber, wherein the third scrubber comprises: a third chamber defining a third scrubbing space in which another portion of the impurities contained in the gas is scrubbed, a third scrubbing plate disposed in the third chamber and at least partially fixed to an inner side wall of the third chamber, a third solution supply nozzle that supplies a third scrubbing solution onto an upper surface of the third scrubbing plate a third solution supply nozzle that supplies a third scrubbing solution onto an upper surface of the third scrubbing plate, and a plurality of third scrubbing holes penetrating the third scrubbing plate, wherein the first scrubber, the second scrubber, and the third scrubber are arranged in an L-shaped configuration.

In some embodiments, wherein the first scrubber comprises a first gas inlet port through which the gas is introduced into the first chamber, and a first gas outlet port through which the gas is discharged from the first chamber, and wherein the first gas inlet port is formed on one side wall of the first chamber, and the first gas outlet port is formed on an opposite side wall facing the one side wall.

In some embodiments, wherein the first gas inlet port and the first gas outlet port are formed at the same vertical level.

In some embodiments, wherein the second scrubber comprises a second gas inlet port through which the gas is introduced into the second chamber, and wherein the first gas outlet port and the second gas inlet port are connected to each other.

In some embodiments, wherein a vertical lever of the first gas outlet port is higher than a vertical level of the second inlet port.

In some embodiments, wherein the first scrubber comprises a first gas inlet port through which the gas is introduced into the first chamber, and a first gas outlet port through which the gas is discharged from the first chamber, and wherein the first gas inlet port is formed on one side wall of the first chamber, and the first gas outlet port is formed on an opposite side wall intersecting the one side wall.

In some embodiments, wherein the first scrubber comprises a first solution storage tank in which a first impurity among the impurities dissolved in the first scrubbing solution is stored, and wherein the second scrubber comprises a second impurity among the impurities dissolved in the second scrubbing solution is stored.

In some embodiments, wherein the concentration of the first impurity in the solution stored in the first solution storage tank is greater than the concentration of the second impurity in the solution stored in the second solution storage tank.

Specific details of other embodiments are included in the specification and drawings.

### Effect of Invention

The scrubbing apparatus of the present invention includes at least one scrubbing plate. Scrubbing holes penetrating the scrubbing plate are formed in the scrubbing plate. As the gas ascends through the scrubbing holes, bubbles may be formed within the scrubbing solution flowing on an upper surface of the scrubbing plate.

As the bubbles are formed, the contact area between the scrubbing solution and the gas increases. Due to the increased contact area, hydrophilic impurities in the gas may be dissolved more effectively in the scrubbing solution. Accordingly, the gas from which impurities(contaminants) have been removed may be discharged to the outside of the scrubbing apparatus.

Furthermore, the scrubbing apparatus of the present invention comprises at least one scrubber. A plurality of scrubbers may be connected in a unidirectional sequence, arranged in an L-shaped configuration, or arranged in a U-shaped configuration. Accordingly, a scrubbing apparatus with improved spatial efficiency can be provided.

### BRIEF DESCRIPTION OF DRAWINGS

FIG. 1 is a drawing briefly explaining a scrubbing system including a scrubbing apparatus to some embodiments of the present invention.

FIG. 2 is an exemplary perspective view for explaining the scrubbing apparatus of FIG. 1.

FIG. 3 is an exemplary cross-sectional view for explaining the scrubbing apparatus of FIG. 1.

FIG. 4 is an enlarged view of the P area of FIG. 3.

FIGS. 5, 6, 7, 8, 9, 10, 11 and 12 are drawings for explaining the scrubbing apparatus according to some other embodiments of the present invention.

FIGS. 13 and 14 are drawings for explaining an operating method of a scrubbing apparatus according to some embodiments of the present invention.

### DETAILED DESCRIPTION OF EXEMPLARY EMBODIMENTS

Hereinafter, preferred embodiments of the present invention will be described in detail

with reference to the accompanying drawings. The advantages and features of the present invention and the methods for achieving them will become apparent with reference to the embodiments described in detail below together with the accompanying drawings. However, the present invention is not limited to the embodiments described below, but may be implemented in various different forms, and these embodiments are provided only to make the invention of the present invention complete and to fully inform those skilled in the art of the scope of the invention, and the present invention is defined only by the scope of the claims. Like reference numerals refer to like elements throughout the specification.

In addition, the terminology used herein is for the purpose of describing embodiments, and is not intended to limit and/or restrict the disclosed invention. The singular expression includes the plural expression unless the context clearly indicates otherwise. In this specification, the terms “comprises”, “include”, or “has” and the like are intended to specify that a feature, number, step, operation, component, part, or combination thereof described in the specification is present, but do not exclude in advance the possibility of the presence or addition of one or more other features, numbers, steps, operations, components, parts, or combinations thereof.

In addition, terms including ordinal numbers such as “first”, “second”, etc. used in this specification may be used to describe various components, but the components are not limited by the terms, and the terms are used only for the purpose of distinguishing one component from another. For example, without departing from the scope of the present invention, the first component may be named the second component, and similarly, the second component may also be named the first component. The term “and/or” includes a combination of multiple related described items or any item among multiple related described items.

Meanwhile, the terms “front”, “rear”, “upper”, “lower”, “front”, and “lower” used in the following description are defined based on the drawings, and the shape and position of each component are not limited by these terms.

The terms used in this specification are for describing embodiments and are not intended to limit the present invention. In this specification, the singular includes the plural unless specifically stated in the phrase. The terms “comprise” and/or “comprising” used in the specification do not exclude the presence or addition of one or more other components, steps, operations, and/or elements mentioned.

Unless otherwise defined, all terms (including technical and scientific terms) used in this specification may be used in a meaning that can be commonly understood by a person of ordinary skill in the art to which the present invention belongs. In addition, terms defined in commonly used dictionaries shall not be ideally or excessively interpreted unless explicitly specifically defined.

Hereinafter, embodiments of the present invention will be described in detail with reference to the attached drawings, and when describing with reference to the attached drawings, identical or corresponding components will be given the same reference numerals regardless of the drawing numbers, and redundant descriptions thereof will be omitted.

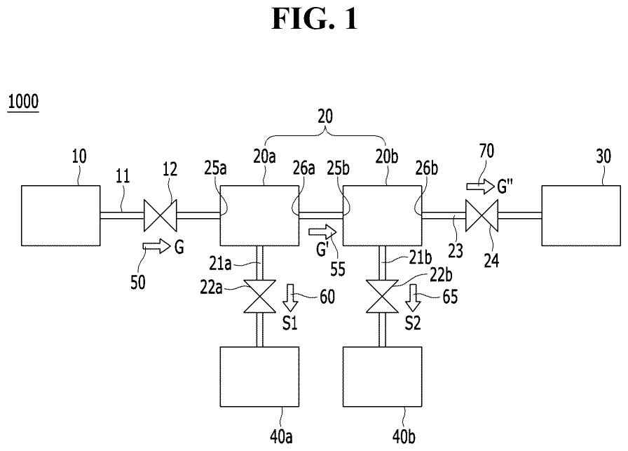

Hereinafter, first, a scrubbing system 1000 including a scrubbing apparatus 20 according to some embodiments of the present invention will be described with reference to FIG. 1. FIG. 1 is a drawing briefly explaining the scrubbing system including the scrubbing apparatus according to some embodiments of the present invention.

Referring to FIG. 1, the scrubbing system 1000 according to some embodiments of the present invention may include a process chamber 10, a scrubbing apparatus 20, an exhaust gas discharge chamber 30, a first scrubbing solution discharge chamber 40a, and a second scrubbing solution discharge chamber 40b.

The scrubbing apparatus 20 may include at least one scrubber. For example, the scrubbing apparatus 20 may include a first scrubber 20a and a second scrubber 20b, however, technical scope of the present invention is not limited thereto.

The process chamber 10 may be a chamber utilized in various industrial fields. The various industrial fields may be a plant field, a battery field, a thermal power plant field, a steel field, a semiconductor field, a chemical field, and/or an oil and gas plant field.

If the scrubbing system 1000 is utilized in the semiconductor field, the process chamber 10 may be a chamber in which a semiconductor process is performed. In order to manufacture a semiconductor device, various semiconductor processes must be performed on a wafer. For example, a film must be deposited on the wafer(deposition process), and the film must be etched (etching process) to form a pattern included in the semiconductor device. In addition, after the deposition process and/or the etching process are performed, a cleaning process must be performed to clean the wafer and/or the process chamber10.

The deposition process may include, for example, physical vapor deposition (PVD), chemical vapor deposition (CVD), and/or atomic layer deposition (ALD). The etching process may include, for example, a dry etching process, a wet etching process, and/or an ashing process. The cleaning process may include, for example, a wet cleaning process, a dry cleaning process, and/or a vapor cleaning process.

If the scrubbing system 1000 is utilized in the oil and gas plant industry, the process chamber 10 may be a chamber where the plant process is performed.

When various processes are performed in the process chamber 10, various byproducts may be generated. The byproducts may include substances harmful to the human body, and if the byproducts include substances harmful to the human body, they must be removed and discharged. The scrubbing apparatus 20 may be used to remove substances harmful to the human body and the byproducts generated in the process chamber 10.

A first pipe 11 may be disposed between the process chamber 10 and the scrubbing apparatus 20. One end of the first pipe 11 may be connected to the process chamber 10, and the other end of the first pipe 11 may be connected to the scrubbing apparatus 20. Specifically, the other end of the first pipe 11 may be connected to the first scrubber 20a. A gas G discharged from the process chamber 10 may be provided to the scrubbing apparatus 20 through the first pipe 11 (see reference numeral 50). The gas G may contain impurities. The impurities may be substances harmful to the human body. The impurities may contain hydrophilic substances.

In some embodiments, a first valve 12 may be connected to the first pipe 11. The first valve 12 may control the pressure and flow rate of the gas G provided to the scrubbing apparatus 20 through the first pipe 11.

The scrubbing apparatus 20 may scrub the gas G provided from the process chamber 10. The impurities contained in the gas G may be dissolved in a scrubbing solution and stored in the first and second scrubbing solution discharge chamber 40a, 40b.

Specifically, the gas G is supplied to the first scrubber 20a. The first scrubber 20a may scrub the gas G, and a portion of the impurities contained in the gas G may dissolve into the first scrubbing solution and be stored in the first scrubbing solution discharge chamber 40a. The first scrubbing soliton may include a first-1 scrubbing solution 225a and a first-2 scrubbing solution 227a, which will be described later.

The gas G′ that has been scrubbed primarily by the first scrubber 20a is provided to the second scrubber 20b (see reference numeral 55). The second scrubber 20b may perform secondary scrubbing on the gas G′ that has undergone primary scrubbing, and another portion of the impurities contained in the primarily scrubbed gas G′ may dissolve into the second scrubbing solution and be stored in the second scrubbing solution discharge chamber 40b. The second scrubbing solution may include a second-1 scrubbing solution 225b and a second-2 scrubbing solution 227b.

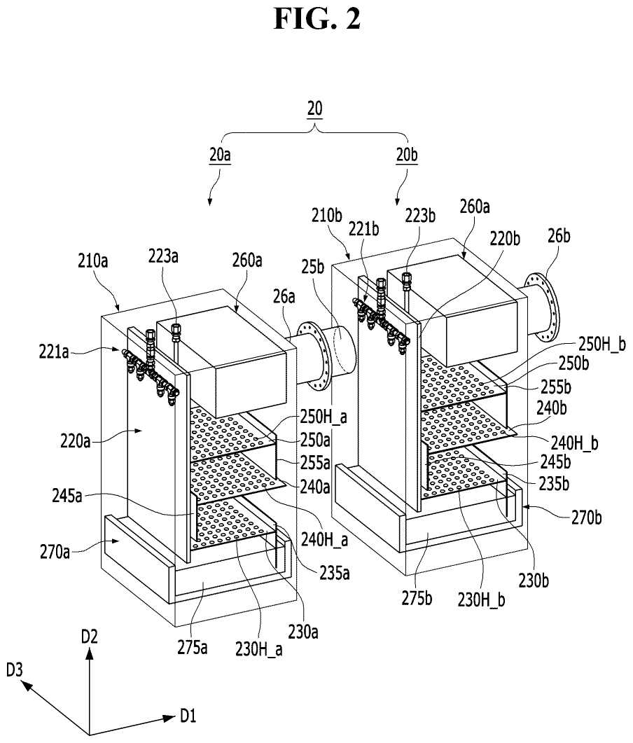

The gas G′ from which the impurities have been removed may be stored in the exhaust gas discharge chamber 30. A detailed description of the scrubbing apparatus 20 will be described later using FIGS. 2 to 12.

The first scrubbing solution discharge chamber 40a may be connected to the first scrubber 20a. The first scrubbing solution discharge chamber 40a and the first scrubber 20a may be connected to each other through a second pipe 21a. One end of the second pipe 21a may be connected to the first scrubber 20a, and the other end of the second pipe 21a may be connected the first scrubbing solution discharge chamber 40a. Through the second pipe 21a, the scrubbing solution S1 in which a first impurity is dissolved may move from the first scrubber 20a to the first scrubbing solution discharge chamber 40a (see reference numeral 60).

In some embodiments, a second valve 22a may be connected to the second pipe 21a. The second valve 22a may control the pressure and flow rate of the scrubbing solution S1 in which the first impurity is dissolved supplied to the first scrubbing solution discharged chamber 40a through the second pipe 21a.

The second scrubbing solution discharge chamber 40b may be connected to the second scrubber 20b. The second scrubbing solution discharge chamber 40b and the second scrubber 20a may be connected to each other through a third pipe 21b. One end of the third pipe 21b may be connected to the second scrubber 20b, and the other end of the third pipe 21b may be connected the second scrubbing solution discharge chamber 40b. Through the third pipe 21b, the scrubbing solution S2 in which a second impurity is dissolved may move from the second scrubber 20b to the second scrubbing solution discharge chamber 40b (see reference numeral 65).

In some embodiments, a third valve 22b may be connected to the third pipe 21b. The third valve 22b may control the pressure and flow rate of the scrubbing solution S2 in which the second impurity is dissolved supplied to the second scrubbing solution discharged chamber 40b through the third pipe 21b.

The exhaust gas discharge chamber 30 may be connected to the scrubbing apparatus 20. Specifically, the exhaust gas discharge chamber 30 may be connected to the second scrubber 20b. The exhaust gas discharge chamber 30 and the scrubbing apparatus 20 may be connected to each other through a fourth pipe 23. One end of the fourth pipe 23 may be connected to the scrubbing apparatus 20, and the other end of the fourth pipe 23 may be connected to the exhaust gas discharge chamber 30. Through the fourth pipe 23, the gas G′ from which impurities have been removed may move from the scrubbing apparatus 20 to the exhaust gas discharge chamber 30 (see reference numeral 70).

In some embodiments, a fourth valve 24 may be connected to the fourth pipe 23. The fourth valve 24 may control the pressure and flow rate of the gas G′ from which impurities have been removed and provided to the exhaust gas discharge chamber 30 through the fourth pipe 23.

In some embodiments, the first scrubber 20a may further include a first gas inlet port 25a and a first gas outlet port 26a. The gas G may be introduced into the first scrubber 20a through the first gas inlet port 25a. The gas G′ from which some impurities have been removed may be discharged to the exterior of the first scrubber 20a through the first gas outlet port 26a. The second scrubber 20b may further include a second gas inlet port 25b and a second gas outlet port 26b. The gas G′ from which some impurities have been removed, may be introduced into the second scrubber 20b through the second gas inlet port 25b. The gas G″ from which impurities have been removed, may be discharged from the second scrubber 20b through the second gas outlet port 26b.

In some embodiments, the impurities scrubbed in the first scrubber 20a and the impurities scrubbed in the second scrubber 20b may be the same or different.

When the scrubbing apparatus 20 according to some embodiments of the present invention is utilized in the industrial field, pollutants generated after the process can be effectively separated and removed. Accordingly, environmental pollution problems can be reduced.

Hereinafter, a scrubbing apparatus according to some embodiments of the present invention will be described in detail with reference to FIGS. 2 to 4.

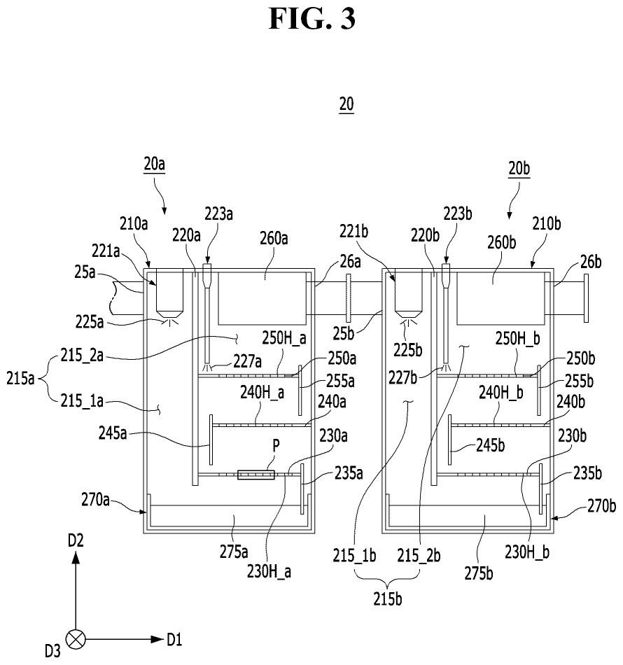

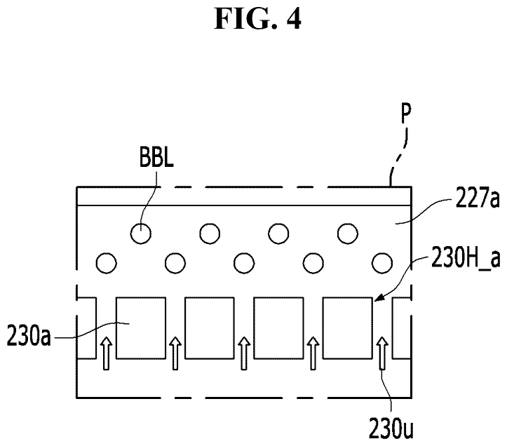

FIG. 2 is an exemplary perspective view for explaining the scrubbing apparatus of FIG. 1. FIG. 3 is an exemplary cross-sectional view for explaining the scrubbing apparatus of FIG. 1. FIG. 4 is an enlarged view of the P area of FIG. 3.

Referring to FIGS. 2 to 4, the scrubbing apparatus 20 according to some embodiments of the present invention may comprise the first scrubber 20a and the second scrubber 20b. The first scrubber 20a and the second scrubber 20b may be substantially same.

The first scrubber 20a and the second scrubber 20b may be connected to each other. Specifically, the first gas outlet port 26a of the first scrubber 20a and the second gas inlet port 25b of the second scrubber 20b may be connected to each other through the pipe. Accordingly, the gas (G′ of FIG. 1) that has been primarily scrubbed by the first scrubber 20a may be supplied to the second scrubber 20b through the first gas outlet port 26a and the second gas inlet port 25b.

The first scrubber 20a may include a first chamber 210a, a first separating wall 220a, a first-1 scrubbing plate 230a, a first-2 scrubbing plate 240a, a first-3 scrubbing plate 250a, a first spray nozzle 221a, a first solution supply nozzle 223a, and a first demister 260a.

First, the first chamber 210a may be provided. The first chamber 210a may be an outer housing of the first scrubber 20a. The gas (G of FIG. 1) may be provided in the first chamber 210a. The gas may contain impurities. The impurities may include a first impurity and a second impurity. The first impurity may be primarily scrubbed in the first scrubber 20a. The second impurity may be secondarily scrubbed in the second chamber 20b.

Specifically, the gas may be provided into an interior of the first chamber 210a through the first gas inlet port 25a. The first gas inlet port 25a may be formed on an upper wall of the first chamber 210a or a side wall of the first chamber 210a. Also, the first gas inlet port 25a may be formed on an upper part of the first chamber 210a or a lower part of the first chamber 210a.

The first impurity may be dissolved in the first scrubbing solution inside the first chamber 210a. The first chamber 210a may define a first scrubbing space 215a. The first scrubbing space 215a may be a space in which a first scrubbing process is performed, in which the first impurity is primarily dissolved in the first scrubbing solution.

In some embodiments, the first scrubbing space 215a may be include a first-1 sub-space 215_1a and a first-2 sub-space 215_2a. The first-1 sub-space 215_1a and the first-2 sub-space 215_2a may be divided by the first separating wall 220a. The first-1 sub-space 215_1a and the first-2 sub-space 215_2a may be defined by the first separating wall 220a.

The first separating wall 220a may be disposed in the first chamber 210a. In some embodiments, the first separating wall 220a may be attached to the upper wall of the first chamber 210a. The first separating wall 220a may extend from the upper wall of the first chamber 210a in a second direction D2. The second direction D2 may be a direction perpendicular to the ground.

A first-1 scrubbing process may be performed in the first-1 sub-space 215_1a. A first-2 scrubber process may be performed in the first-2 sub-space 215_2a. The first-1 scrubbing process may be a process in which a portion of the first impurity is dissolved in the first-1 scrubbing solution 225a.

The first-2 scrubbing process may be a process in which another portion of the first impurity is dissolved in the first-2 scrubbing solution 227a. The first-1 scrubbing process and the first-2 scrubbing process may together constitute the first scrubbing process.

In some embodiments, the first-1 scrubbing solution 225a may be the same as or different from the first-2 scrubbing solution 227a.

In this specification, the first direction D1 and the third direction D3 may intersect each other. The first direction D1 and the second direction D2 may intersect each other. The second direction D2 and the third direction D3 may intersect each other. That is, in this specification, the first direction D1, the second direction D2, and the third direction D3 may be substantially perpendicular to each other.

In some embodiments, the first-1 scrubbing plate 230a, the first-2 scrubbing plate 240a, and the first-3 scrubbing plate 250a may be disposed in the first scrubbing space 215a.

In FIGS. 2 to 4, the first scrubber 20a of the present invention is illustrated as including three scrubbing plates, but the technical scope of the present invention is not limited thereto. The scrubber according to some embodiments of the present invention may include at least one scrubbing plate. That is, one or two scrubbing plates may be arranged inside the scrubber, or four or more may be arranged.

The first-1 scrubbing plate 230a may be arranged at the lowest position among the scrubbing plates arranged inside the first-2 sub-space 215_2a. One end of the first-1 scrubbing plate 230a may be connected to and fixed to the first separating wall 220a. The first-1 scrubbing plate 230a may be connected to the first separating wall 220a and may extend in the first direction D1 intersecting the first separating wall 220a. More specifically, the first-1 scrubbing plate 230a may be positioned on a plane defined by the first direction D1 and the third direction D3.

In some embodiments, another portion of the first-1 scrubbing plate 230a may be connected and fixed to the inner side walls of the first chamber 210a. Specifically, the first-1 scrubbing plate 230a may be connected to the inner side walls of the first chamber 210a intersecting the first separating wall 220a.

However, the first-1 scrubbing plate 230a may not be fixedly connected to one inner side wall of the first chamber 210a facing the first separating wall 220a. The first-1 scrubbing plate 230a may be spaced apart from the one inner side wall of the first chamber 210a in the first direction D1. The space from the other end of the first-1 scrubbing plate 230a to the one inner side wall of the first chamber 210a may be a space in which the first-2 scrubbing solution 227a, which will be described later, flows downward (for example, in the second direction D2).

The first scrubber 20a according to some embodiments may further include a first-1 scrubbing hole 230H_a and a first-1 scrubbing wall 235a.

The first-1 scrubbing hole 230H_a may be formed inside the first-1 scrubbing plate 230a. The first-1 scrubbing hole 230H_a may extend from a lower surface of the first-1 scrubbing plate 230a to an upper surface of the first-1 scrubbing plate 230a. That is, the first-1 scrubbing hole 230H_a may penetrate the first-1 scrubbing plate 230a in the second direction D2. The gas (G of FIG. 1) may ascend in the second direction D2 by passing through the first-1 scrubbing hole 230H_a (see reference numeral 230u).

The upper surface of the first-1 scrubbing plate 230a may face the first demister 260a to be described later, and the lower surface of the first-1 scrubbing plate 230a may face the first scrubbing solution storage tank 270a to be described later.

The first-1 scrubbing wall 235a may be attached to the other end of the first-1 scrubbing plate 230a. The first-1 scrubbing wall 235a may be interposed between the first-1 scrubbing plate 230a and the one inner side wall of the first chamber 210a. The first-1 scrubbing wall 235a may extend in the second direction D2. In some embodiments, a portion of the first-1 scrubbing wall 235a may protrude from the upper surface of the first-1 scrubbing plate 230a in the second direction D2. Another portion of the first-1 scrubbing wall 235a may protrude from the lower surface of the first-1 scrubbing plate 230a in the second direction D2.

The length in the second direction D2 of the portion of the first-1 scrubbing wall 235a protruding from the upper surface of the first-1 scrubbing plate 230a may be less than the length in the second direction D2 of the portion protruding from the lower surface of the first-1 scrubbing plate 230a, but the technical scope of the present invention is not limited thereto.

In some embodiments, at least a portion of the first-1 scrubbing plate 230a protruding from the lower surface of the first-1 scrubbing wall 235a in the second direction D2 may be placed in the scrubbing solution 275a in which the first impurity is dissolved, but the technical scope of the present invention is not limited thereto.

The first-2 scrubbing plate 240a may be disposed on the first-1 scrubbing plate 230a. Specifically, the first-2 scrubbing plate 240a may be disposed on the upper surface of the first-1 scrubbing plate 230a. One end of the first-2 scrubbing plate 240a may be connected to and fixed to one inner side wall of the first chamber 210a. The first-2 scrubbing plate 240a may be connected to the one inner side wall of the first chamber 210a and may extend in the first direction D1 intersecting the one inner side wall of the first chamber 210a. More specifically, the first-2 scrubbing plate 240a may be placed on a plane on which the first direction D1 and the third direction D3 extend.

Similarly, the first-2 scrubbing plate 240a may be connected to and fixed to the inner side walls of the first chamber 210a intersecting the first separating wall 220a.

However, the other end of the first-2 scrubbing plate 240a may not be fixedly connected to the first separating wall 220a. The other end of the first-2 scrubbing plate 240a may be spaced apart from the side wall of the first separating wall 220a in the first direction D1. The space from the other end of the first-2 scrubbing plate 240a to the first separating wall 220a may be a space in which the first-2 scrubbing solution 227a, which will be described later, flows downward (for example, in the second direction D2).

In some embodiments, the first scrubber 20a according to some embodiments may further include a first-2 scrubbing hole 240H_a and a first-2 scrubbing wall 245a.

The first-2 scrubbing hole 240H_a may be formed inside the first-2 scrubbing plate 240a. The first-2 scrubbing hole 240H_a may extend from a lower surface of the first-2 scrubbing plate 240a to an upper surface of the first-2 scrubbing plate 240a. The first-2 scrubbing hole 240H_a may penetrate the first-2 scrubbing plate 240a in the second direction D2. The gas (G of FIG. 1) may ascend in the second direction D2 by passing through the first-2 scrubbing hole 240H_a.

The upper surface of the first-2 scrubbing plate 240a may face the first demister 260a to be described later, and the lower surface of the first-2 scrubbing plate 240a may face the upper surface of the first-1 scrubbing plate 230a.

The first-2 scrubbing wall 245a may be attached to the other end of the first-2 scrubbing plate 240a. The first-2 scrubbing wall 245a may be interposed between the first-2 scrubbing plate 240a and the first separating wall 220a. The first-2 scrubbing wall 245a may extend in the second direction D2. In some embodiments, a portion of the first-2 scrubbing wall 245a may protrude from the upper surface of the first-2 scrubbing plate 240a in the second direction D2. Another portion of the first-2 scrubbing wall 245a may protrude from the lower surface of the first-2 scrubbing plate 240a in the second direction D2.

A length in the second direction D2 of the portion protruding in the second direction D2 from the upper surface of the first-2 scrubbing plate 240a among the first-2 scrubbing wall 245a may be less than a length in the second direction D2 of the portion protruding in the second direction D2 from the lower surface of the first-2 scrubbing plate 240a, but the technical scope of the present invention is not limited thereto.

In some embodiments, the first-1 scrubbing plate 230a and the first-2 scrubbing plate 240a do not completely overlap in the second direction D2. The first-1 scrubbing plate 230a and the first-2 scrubbing plate 240a may be arranged in a zigzag configuration. Accordingly, the first-2 scrubbing solution 227a that flows downward over the first-2 scrubbing wall 245a may be discharged onto the upper surface of the first-1 scrubbing plate 230a. In other words, a center of the first-1 scrubbing plate 230a and a center of the first-2 scrubbing plate 240a may be offset from each other.

The first-3 scrubbing plate 250a may be disposed on the first-2 scrubbing plate 240a. Specifically, the first-3 scrubbing plate 250a may be disposed on the upper surface of the first-2 scrubbing plate 240a. One end of the first-3 scrubbing plate 250a may be connected to and fixed to the first separating wall 220a. The first-3 scrubbing plate 250a may be connected to the first separating wall 220a and may extend in the first direction D1 intersecting the first separating wall 220a.

More specifically, the first-3 scrubbing plate 250a may be positioned on a plane defined by the first direction D1 and the third direction D3. Likewise, the first-3 scrubbing plate 250a may be connected to and fixed to inner side walls of the first chamber 210a intersecting the first separating wall 220a.

However, the other end of the first-3 scrubbing plate 250a may not be connected to and fixed to the one inner side wall of the first chamber 210a. The other end of the first-3 scrubbing plate 250a may be spaced apart from the one inner side wall of the first chamber 210a in the first direction D1. The space from the other end of the first-3 scrubbing plate 250a to the one inner side wall of the first chamber 210a may be a space in which the first-2 scrubbing solution 227b, which will be described later, flows downward (for example, in the second direction D2).

The scrubber 20a according to some embodiments may further include a first-3 scrubbing hole 250H_a and a first-3 scrubbing wall 255a.

The first-3 scrubbing hole 250H_a may be formed inside the third scrubbing plate 250. The first-3 scrubbing hole 250H_a may extend from the lower surface of the first-3 scrubbing plate 250a to the upper surface of the first-3 scrubbing plate 250a. The first-3 scrubbing hole 250H_a may penetrate the first-3 scrubbing plate 250a in the second direction D2. The gas (G of FIG. 1) may ascend in the second direction D2 by passing through the first-3 scrubbing hole 250H_a.

The upper surface of the first-3 scrubbing plate 250a may face the first demister 260a to be described later, and the lower surface of the first-3 scrubbing plate 250a may face the upper surface of the first-2 scrubbing plate 240a.

The first-3 scrubbing wall 255a may be attached to the other end of the first-3 scrubbing plate 250a. The first-3 scrubbing wall 255a may be interposed between the first-3 scrubbing plate 250a and the one inner side wall of the first chamber 210a. The first-3 scrubbing wall 255a may extend in the second direction D2.

In some embodiments, a portion of the first-3 scrubbing wall 255a may protrude in the second direction D2 from the upper surface of the first-3 scrubbing plate 250a. Another portion of the first-3 scrubbing wall 255a may protrude in the second direction D2 from the lower surface of the first-3 scrubbing plate 250a.

A length in the second direction D2 of the portion protruding in the second direction D2 from the upper surface of the first-3 scrubbing plate 250a among the first-3 scrubbing wall 255a may be less than a length in the second direction D2 of the portion protruding in the second direction D2 from the lower surface of the first-3 scrubbing plate 250a, but the technical scope of the present invention is not limited thereto.

In some embodiments, the first-3 scrubbing plate 250a and the first-2 scrubbing plate 240a do not completely overlap in the second direction D2. The first-3 scrubbing plate 250a and the first-2 scrubbing plate 240a may be arranged in a zigzag configuration. The first-2 scrubbing solution 227a that flows downward over the first-3 scrubbing wall 255a may be discharged onto the upper surface of the first-2 scrubbing plate 240a. In other words, a center of the first-3 scrubbing plate 250a and the center of the first-2 scrubbing plate 240a may be offset from each other.

However, the first-3 scrubbing plate 250a and the first-1 scrubbing plate 230a may completely overlap in the second direction D2. That is, the center of the first-3 scrubbing plate 250a and the center of the first-1 scrubbing plate 230a may overlap in the second direction D2.

In some embodiments, the first-1 to first-3 scrubbing holes 230H_a, 240H_a, and 250H_a may completely overlap in the second direction D2. However, the technical scope of the present invention is not limited thereto. The first-1 to first-3 scrubbing holes 230H_a, 240H_a, and 250H_a may not completely overlap in the second direction D2, and may only partially overlap.

The first solution supply nozzle 223a may be disposed in the first chamber 210a. The first solution supply nozzle 223a may be connected to the upper part of the first chamber 210a and may extend in the second direction D2. The first solution supply nozzle 223a may be connected to a pipe (not shown) installed outside the first chamber 210a. The first solution supply nozzle 223a may supply the first-2 scrubbing solution 227a to the first-2 sub-space 215_2a. The first-2 scrubbing solution 227a may be supplied from the first solution supply nozzle 223a and discharged to the upper surface of the first-3 scrubbing plate 250a.

The first-2 scrubbing solution 227a may be, for example, water. However, the technical scope of the present invention is not limited thereto.

The first-2 scrubbing solution 227a may be discharged onto the upper surface of the first-3 scrubbing plate 250a and may flow from the upper surface of the first-3 scrubbing plate 250a toward the first-3 scrubbing wall 255a while the first-2 scrubbing process is being performed. At this time, the first-2 scrubbing solution 227a does not flow downward through the first-3 scrubbing hole 250H_a. The first-2 scrubbing solution 227a may flow over the first-3 scrubbing wall 255a to the lower part of the first chamber 210a.

The first-2 scrubbing solution 227a that has passed over the first-3 scrubbing wall 255a is discharged again to the upper surface of the first-2 scrubbing plate 240a. The first-2 scrubbing solution 227a may flow from the upper surface of the first-2 scrubbing plate 240a toward the first-2 scrubbing wall 245a while the first-2 scrubbing process is performed. At this time, the first-2 scrubbing solution 227a does not flow downward through the first-2 scrubbing hole 240H_a. The first-2 scrubbing solution 227a may flow over the first-2 scrubbing wall 245a to the lower part of the first chamber 210a.

Similarly, the first-2 scrubbing solution 227a that has passed over the first-2 scrubbing wall 245a is discharged again to the upper surface of the first-1 scrubbing plate 230a. The first-2 scrubbing solution 227a may flow from the upper surface of the first-1 scrubbing plate 230a toward the first-1 scrubbing wall 235a while the first-2 scrubbing process is performed. At this time, the first-2 scrubbing solution 227a does not flow downward through the first-1 scrubbing hole 230H_a. The first-2 scrubbing solution 227a may flow over the first-1 scrubbing wall 235a to the lower part of the first chamber 210a.

Finally, the first-2 scrubbing solution 227a that has passed over the first-1 scrubbing wall 235a may be stored in the first scrubbing solution storage tank 270a provided at the lower part of the first chamber 210a. The first scrubbing solution storage tank 270a may store a scrubbing solution 275a in which the first impurity is dissolved. For example, the scrubbing solution 275a in which the first impurity is dissolved may be a solution in which a hydrophilic gas is dissolved in the first-1 scrubbing solution 225a and the first-2 scrubbing solution 227a. For example, the first impurity may be hydrophilic gas.

In some embodiments, the hydrophilic gas may be isopropyl alcohol (IPA) and/or ammonia, although the technical scope of the present invention is not limited thereto.

The first demister 260a may be disposed on the upper part of the first chamber 210a. The first demister 260a may be used to remove moisture from the gas after the first-1 scrubbing process and the first-2 scrubbing process are performed. After the first-1 scrubbing process and the first-2 scrubbing process are performed, the gas (G′ of FIG. 1) from which some impurities have been removed may be provided. That is, moisture may be removed from the gas (G′ of FIG. 1) from which some impurities have been removed after the first-1 scrubbing process and the first-2 scrubbing process are performed using the first demister 260a.

In some embodiment, the first scrubber 20a may not include the first demister 260a. That is, a demister may not be included in the first scrubber 20a that performs primary scrubbing of the gas, and may instead be included only in the second scrubber 20b that performs final scrubbing of the gas.

The first demister 260a may be connected to the first gas outlet port 26a. The gas filtered through the first demister 260a may be discharged to the outside of the first chamber 210a through the first gas outlet port 26a.

In some embodiments, the first-1 sub-space 215_1a may be defined by the inner side wall of the first chamber 210a and the first separating wall 220a. The first-1 scrubbing process may be performed in the first-1 sub-space 215_1a.

In some embodiments, the first-1 scrubbing solution 225a may be provided into the interior of the first chamber 210a through a first spray nozzle 221a. The first-1 scrubbing solution 225a may be provided into the first-1 sub-space 215_1a through the first spray nozzle 221a.

The first-1 scrubbing solution 225a may be provided from the upper part to the lower part of the first-1 sub-space 215_1a, and while the gas (G of FIG. 1) flows from the upper part to the lower part of the first-1 sub-space 215_1a, at least some of the first impurity contained in the gas may be dissolved in the first-1 scrubbing solution 225a. In some embodiments, the first-1 scrubbing solution 225a may include water. However, the technical scope of the present invention is not limited thereto.

In some embodiments, the first spray nozzle 221a may be a spray nozzle. The first spray nozzle 221a may supply the first-1 scrubbing solution 225a having small particles to the first-1 sub-space 215_1a. Accordingly, the contact area between the first-1 scrubbing solution 225a and the gas may be increased. Accordingly, the scrubbing apparatus 20 with improved scrubbing efficiency may be provided.

The first spray nozzle 221a may be installed on the upper part of the first chamber 210a. Although not shown, the first spray nozzle 221a may be connected to a pipe installed outside the first chamber 210a.

In some embodiments, the first gas inlet port 25a may be installed on one side of the first-1 sub-space 215_1a. The gas G introduced into the first chamber 210a, as shown in FIG. 1, may be supplied into the interior of the first chamber 210a through the first gas inlet port 25a. The first gas inlet port 25a may be connected to the first pipe 11 and the other end of the first pipe 11 may be connected to the process chamber (10 of FIG. 1). Accordingly, the gas (G of FIG. 1) introduced through the gas inlet port may be provided from the process chamber.

In some embodiments, the first gas inlet port 25a and the first gas outlet port 26a may be formed on side walls facing each other. That is, the vertical level of the first gas inlet port 25a and the vertical level of the first gas outlet port 26a may be the same. However, the technical scope of the present invention is not limited thereto.

In another embodiment, the first gas inlet port 25a may be formed on one side wall of the first chamber 210a. The first gas outlet port 26a may be formed on another side wall that intersects the one side wall of the first chamber 210a. That is, the first gas inlet port 25a and the first gas outlet port 26a may be formed on side walls intersecting each other. However, the technical scope of the present invention is not limited thereto.

By variously arranging the first gas inlet port 25a and the first gas outlet port 26a, the spatial efficiency of the scrubbing apparatus 20 according to some embodiments may be improved.

In some embodiments, a negative pressure may be provided to the first scrubbing space 215a through the first gas inlet port 25a and the first gas outlet port 26a. For example, the pressure at the first gas inlet port 25a and the pressure at the first gas outlet port 26a may be different from each other. Accordingly, the gas (G of FIG. 1) may flow from the first gas inlet port 25a toward the first gas outlet port 26a. The first-1 scrubbing process and the first-2 scrubbing process may be performed by utilizing the difference between the pressure at the first gas inlet port 25a and the pressure at the first gas outlet port 26a.

In some embodiments, the first-1 sub-space 215_a and the first-2 sub-space 215_2a may be connected to each other at the lower part of the first chamber 210a. The first-1 sub-space 215_1a and the first-2 sub-space 215_2a may be connected to each other above the first solution storage tank 270a.

That is, the gas injected into the first-1 sub-space 215_1a may flow from the upper part of the first-1 sub-space 215_1a to the lower part of the first-1 sub-space 215_1a and may be injected into the first-2 sub-space 215_2a from the lower part of the first chamber 210. In the first-2 sub-space 215_2a, the gas (G of FIG. 1) may ascent in the second direction D2.

When using the scrubbing apparatus 20 according to some embodiments, the contact area between the scrubbing solution and the gas may be increased. Specifically, bubbles may be formed within the scrubbing solution to increase the contact area between the scrubbing solution and the gas.

For example, in FIG. 4, the gas (G of FIG. 1) may pass through the first-1 scrubbing hole 230H_a and ascend in the second direction D2 (see reference numeral 230u).

After the gas (G of FIG. 1) may ascend through the first-1 scrubbing hole 230H_a, bubbles BBL may be formed on the upper surface of the first-1 scrubbing plate 230a. The bubbles may be formed inside the first-2 scrubbing solution 227a. The impurities contained in the gas may dissolve into the first-2 scrubbing solution 227a at the contact area between the bubbles BBL and the first-2 scrubbing solution 227a.

Although not shown, the gas (G of FIG. 1) may ascend through the first-1 scrubbing hole 230H_a and then continue to ascend through the first-2 scrubbing hole 240H_a in the second direction D2. After the gas (G of FIG. 1) ascends through the first-2 scrubbing hole 240H_a, the bubbles may be formed on the upper surface of the first-2 scrubbing plate 240a. Similarly, after the gas (G of FIG. 1) ascends through the first-2 scrubbing hole 240H_a, the gas may ascend through the first-3 scrubbing hole 250H_a in the second direction D2. After the gas (G of FIG. 1) ascends through the first-3 scrubbing hole 250H_a, the bubbles may be formed on the upper surface of the first-3 scrubbing plate 250a.

When the bubbles BBL are formed in the first-2 scrubbing solution 227a, the contact area between the gas and the scrubbing solution may be increased. Accordingly, the scrubbing apparatus 20 with improved scrubbing efficiency may be provided.

Hereinafter, the second scrubber 20b will be described. Since the second scrubber 20b may be substantially the same as the first scrubber 20a, redundant descriptions will be briefly explained or omitted.

The second scrubber 20b may include a second chamber 210b, a second separating wall 220b, a second-1 scrubbing plate 230b, a second-2 scrubbing plate 240b, a second-3 scrubbing plate 250b, a second spray nozzle 221b, a second solution supply nozzle 223b, and a second demister 260b.

First, the second chamber 210b may be provided. The second chamber 210b may be an outer housing of the second scrubber 20b. The gas (G′ of FIG. 1) that has been primarily scrubbed may be supplied to the second chamber 210b. The gas that has passed through the first chamber 210a and has been primarily scrubbed may be in a state in which some impurities have been removed.

For example, the gas that has been primarily scrubbed may be supplied into the second chamber 210b through the second gas inlet port 25b. The second gas inlet port 25b may be formed on the side wall of the second chamber 210b. The second gas inlet port 25b may be formed at the same vertical level as the first gas outlet port 26a. For example, based on a bottom surface of the first chamber 210a, the height of the first gas outlet port 26a and the height of the second gas inlet port 25b may be the same. However, the technical scope of the present invention is not limited thereto.

The second impurity contained in the gas has been primarily scrubbed may be dissolved in the second scrubbing solution inside the second chamber 210b. The second chamber 210b may define a second scrubbing space 215b. The second scrubbing space 215b may be a space in which the second scrubbing process is performed, in which the second impurity is secondarily dissolved in the scrubbing solution. It is to be understood that the first impurity and the second impurity may be the same or different.

In some embodiments, the second scrubbing space 215b may include a second-1 sub-space 215_1b and a second-2 sub-space 215_2b. The second-1 sub-space 215_1b and the second-2 sub-space 215_2b may be divided by the second separating wall 220b. The second-1 sub-space 215_1b and the second-2 sub-space 215_2b may be defined by the second separating wall 220b.

The second separating wall 220b may be disposed in the second chamber 210b. In some embodiments, the second separating wall 220b may be attached to the upper wall of the second chamber 210b. The second separating wall 220b may extend from the upper wall of the second chamber 210b in the second direction D2. The second direction D2 may be a direction perpendicular to the ground.

A second-1 scrubbing process may be performed in the second-1 sub-space 215_1b. A second-2 scrubbing process may be performed in the second-2 sub-space 215_2b. The second-1 scrubbing process may be a process in which a portion of the second impurity is dissolved in the second-1 scrubbing solution 225b. The second-2 scrubbing process may be a process in which another portion of the second impurity is dissolved in the second-2 scrubbing solution 227b. The second-1 scrubbing process and the second-2 scrubbing process may together constitute the second scrubbing process.

In some embodiments, the second-1 scrubbing solution 225b may be the same as or different from the second-2 scrubbing solution 227b.

The second-1 scrubbing plate 230b, the second-2 scrubbing plate 240b, and the second-3 scrubbing plate 250b are disposed in the second-2 sub-space 215_2b.

In FIGS. 2 to 4, the second scrubber 20b of the present invention is illustrated as including three scrubbing plates, but the technical scope of the present invention is not limited thereto. The scrubber according to some embodiments of the present invention may include at least one scrubbing plate. That is, one or two scrubbing plates may be arranged inside the scrubber, or four or more may be arranged.

In some embodiments, the number of scrubbing plates disposed in the first scrubber 20a may be different from the number of scrubbing plates disposed in the second scrubber 20b. For example, the number of scrubbing plates disposed in the first scrubber 20a may be greater than the number of scrubbing plates disposed in the second scrubber 20b. By disposing a greater number of scrubbing plates in the first scrubber 20a, which performs primary scrubbing of the gas, scrubbing efficiency and spatial efficiency may be improved.

The second-1 scrubbing plate 230b, the second-2 scrubbing plate 240b, and the second-3 scrubbing plate 250b may be substantially the same as the first-1 scrubbing plate 230a, the first-2 scrubbing plate 240a, and the first-3 scrubbing plate 250a, respectively. Therefore, a detailed description thereof will be omitted.

The second scrubber 20b according to some embodiments may further include a second-1 scrubbing hole 230H_b, a second-1 scrubbing wall 235b, a second-2 scrubbing hole 240H_b, a second-2 scrubbing wall 245b, a second-3 scrubbing hole 250H_b, and a second-3 scrubbing wall 255b.

The second-1 scrubbing hole 230H_b, the second-1 scrubbing wall 235b, the second-2 scrubbing hole 240H_b, the second-2 scrubbing wall 245b, the second-3 scrubbing hole 250H_b, and the second-3 scrubbing wall 255b may be substantially the same as the first-1 scrubbing hole 230H_a, the first-1 scrubbing wall 235a, the first-2 scrubbing hole 240H_a, the first-2 scrubbing wall 245a, the first-3 scrubbing hole 250H_a, and the first-3 scrubbing wall 255a, respectively. Therefore, a detailed description thereof will be omitted.

The solution supply nozzle 223b may be disposed inside the second chamber 210b. The solution supply nozzle 223b may be connected to the upper part of the second chamber 210b, and may extend in the second direction D2. The solution supply nozzle 223b may be connected to the pipe (not shown) installed outside the second chamber 210b. The second solution supply nozzle 223b may supply the second-2 scrubbing solution 227b to the second-2 sub-space 215_2b. The second-2 scrubbing solution 227b may be supplied from the second solution supply nozzle 223b and discharged to the upper surface of the second-3 scrubbing plate 250b.

The second-2 scrubbing solution 227b may be, for example, water. However, the technical scope of the present invention is not limited thereto.

The second-2 scrubbing solution 227b may be discharged onto the upper surface of the second-3 scrubbing plate 250b and then flow from the upper surface of the second-3 scrubbing plate 250b toward the second-3 scrubbing wall 255b while the second-2 scrubbing process is performed. At this time, the second-2 scrubbing solution 227b does not flow downward through the second-3 scrubbing hole 250H_b. The second-2 scrubbing solution 227b may flow to the lower part of the second chamber 210b over the second-3 scrubbing wall 255b.

The second-2 scrubbing solution 227b, having overflowed the second-3 scrubbing wall 255b, is discharged again onto the upper surface of the second-2 scrubbing plate 240b. The second-2 scrubbing solution 227b may flow from the upper surface of the second-2 scrubbing plate 240b toward the second-2 scrubbing wall 245b while the second-2 scrubbing process is performed. At this time, the second-2 scrubbing solution 227b does not flow downward through the second-2 scrubbing hole 240H_b. The second-2 scrubbing solution 227b may flow to the lower part of the second chamber 210b over the second-2 scrubbing wall 245b.

Similarly, the second_2 scrubbing solution 227b, having overflowed the second-2 scrubbing wall 245b, is again discharged to the upper surface of the second_1 scrubbing plate 230b. The second-2 scrubbing solution 227b may flow from the upper surface of the second-1 scrubbing plate 230b toward the second-1 scrubbing wall 235b while the second-2 scrubbing process is performed. At this time, the second-2 scrubbing solution 227b does not flow downward through the second-1 scrubbing hole 230H_b. The second-2 scrubbing solution 227b may flow to the lower part of the second chamber 210b over the second-1 scrubbing wall 235b.

Finally, the second_2 scrubbing solution 227b, having overflowed the second-1 scrubbing wall 235b, may be stored in the second solution storage tank 270b provided at the bottom of the second chamber 210b. The second scrubbing solution storage tank 270b may store a scrubbing solution 275b in which the second impurity is dissolved. For example, the scrubbing solution 275b in which the second impurity is dissolved may be a solution in which a hydrophilic gas is dissolved in the second-1 scrubbing solution 225b and the second-2 scrubbing solution 227b. For example, the second impurity may be hydrophilic gas.

In some embodiments, the concentration of the first impurity stored in the first solution storage tank 270a is greater than the concentration of the second impurity stored in the second solution storage tank 270b. This may be because the amount of impurities scrubbed by the first scrubber 20a is greater than the amount of impurities scrubbed by the second scrubber 20b.

The second demister 260b may be disposed on the upper part of the second chamber 210b. The second demister 260b may be substantially the same as the first demister 260a. The second demister 260b may be connected to the second gas outlet port 26b. The gas filtered through the second demister 260b may be discharged to the outside of the second chamber 210b through the second gas outlet port 26b.

In some embodiments, the second-1 sub-space 215_1b may be defined by the inner side wall of the second chamber 210b and the second separating wall 220b. The second-1 scrubbing process may be performed in the second-1 sub-space 215_1b.

In some embodiments, the second-1 scrubbing solution 225b may be supplied into the second chamber 210b through the second spray nozzle 221b. The second-1 scrubbing solution 225b may be supplied into the second-1 sub-space 215_1b through the second spray nozzle 221b.

The second-1 scrubbing solution 225b may be supplied from the upper part to the lower part of the second-1 sub-space 215_1b, and while the gas (G′ of FIG. 1) from which some impurities have been removed flows from the upper part to the lower part of the second-1 sub-space 215_1b, at least a portion of the second impurity contained in the gas may be dissolved in the second-1 scrubbing solution 225b. In some embodiments, the second-1 scrubbing solution 225b may include water. However, the technical scope of the present invention is not limited thereto.

In some embodiments, the second spray nozzle 221b may be a spray nozzle. The second spray nozzle 221b may supply the second-1 scrubbing solution 225b having small particles to the second-1 sub-space 215_1b. Accordingly, the contact area between the second-1 scrubbing solution 225b and the gas may be increased. Accordingly, the scrubbing apparatus 20 with improved scrubbing efficiency may be provided.

The second spray nozzle 221b may be installed on the upper part of the second chamber 210b. Although not shown, the second spray nozzle 221b may be connected to a pipe installed outside the second chamber 210b.

In some embodiments, the second spray nozzle 221b and the second solution supply nozzle 223b may each be connected to the second solution storage tank 270b via the pipe (not shown) that is connected to the second solution storage tank 270b.

The solution stored in the second solution storage tank 270b may be recycled using the pipe. For example, the second-1 scrubbing solution 225b supplied to the second-1 sub-space 215_1b through the second spray nozzle 221b may be the scrubbing solution 275b, in which the second impurity is dissolved, stored in the second solution storage tank 270b. Likewise, the second-2 scrubbing solution 227b supplied to the second-2 sub-space 215_2b through the second solution supply nozzle 223b may also be the scrubbing solution 275b, in which the second impurity is dissolved, stored in the second solution storage tank 270b.

In some embodiments, the solution stored in the second solution storage tank 270b may be recycled in the first scrubber 20a.

Since the concentration of impurities in the solution stored in the second solution storage tank 270b is low, the solution stored in the second solution storage tank 270b may be recycled. In this manner, when the scrubbing apparatus 20 of the present invention is used, the scrubbing solution may be recycled, and accordingly, the amount of scrubbing solution used in the scrubbing process may be reduced.

In some embodiments, the second gas inlet port 25b may be installed on one side of the second-1 sub-space 215_1b. The gas (G′ of FIG. 1) from which some impurities have been removed and introduced into the interior of the second chamber 210b may be introduced into the interior of the second chamber 210b through the second gas inlet port 25b.

In some embodiments, a negative pressure may be provided to the second scrubbing space 215b through the second gas inlet port 25b and the second gas outlet port 26b. For example, the pressure at the second gas inlet port 25b and the pressure at the second gas outlet port 26b may be different from each other. Accordingly, the gas (G′ of FIG. 1) from which some impurities have been removed may flow from the second gas inlet port 25b toward the second gas outlet port 26b. The second-1 scrubbing process and the second-2 scrubbing process may be performed by utilizing the difference between the pressure at the second gas inlet port 25b and the pressure at the second gas outlet port 26b.

In some embodiments, the second-1 sub-space 215_1b and the second-2 sub-space 215_2b may be connected to each other at the bottom of the second chamber 210b. The second-1 sub-space 215_1b and the second-2 sub-space 215_2b may be connected to each other above the second solution storage tank 270b.

That is, the gas introduced into the second sub-space 215_1b flows from the upper part to the lower part of the second-1 sub-space 215_1b and may be introduced into the second-2 sub-space 215_2b from the lower part of the second chamber 210b. The gas (G′ of FIG. 1) from which some impurities have been removed in the second-2 sub-space 215_2b, may ascend in the second direction D2.

When the scrubbing apparatus 20 according to some embodiments is used, the contact area between the scrubbing solution and the gas can be increased. Specifically, the contact area between the scrubbing solution and the gas may be enhanced by generating bubbles within the scrubbing solution.

When the scrubbing apparatus 20 according to some embodiments is used, gas that is harmful to the human body (e.g., impurities) may be dissolved in the scrubbing solution. Accordingly, harmful gas generated as a by-product after various processes in various industrial fields can be removed and discharged to the outside of the scrubbing apparatus 20.

In addition, when the scrubbing apparatus 20 of the present invention is used, impurities can be secondarily scrubbed using two scrubbers. Therefore, the scrubbing apparatus 20 with improved scrubbing efficiency and spatial efficiency can be provided.

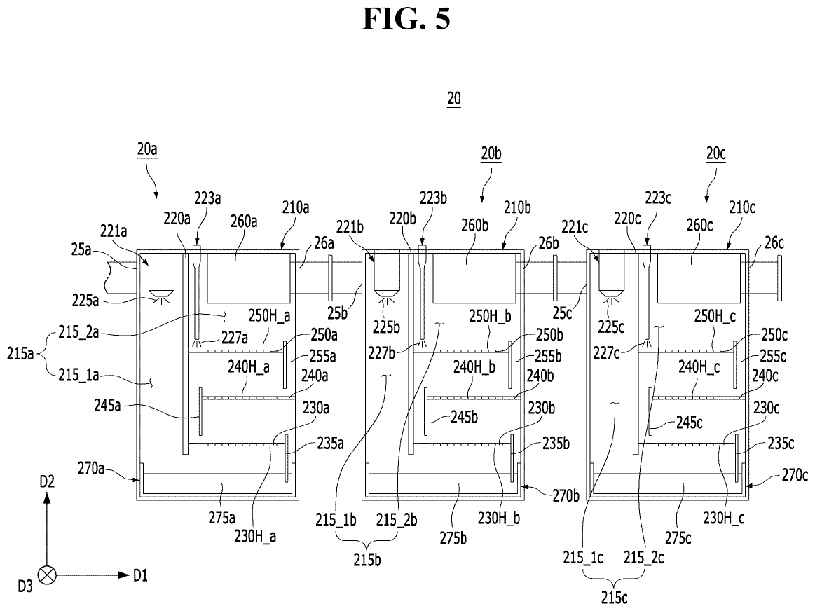

Hereinafter, the scrubbing apparatus according to other embodiments of the present invention will be described with reference to FIGS. 5 to 12. For convenience of explanation, redundant descriptions overlapping with those provided with reference to FIGS. 2 to 4 will be briefly explained or omitted.

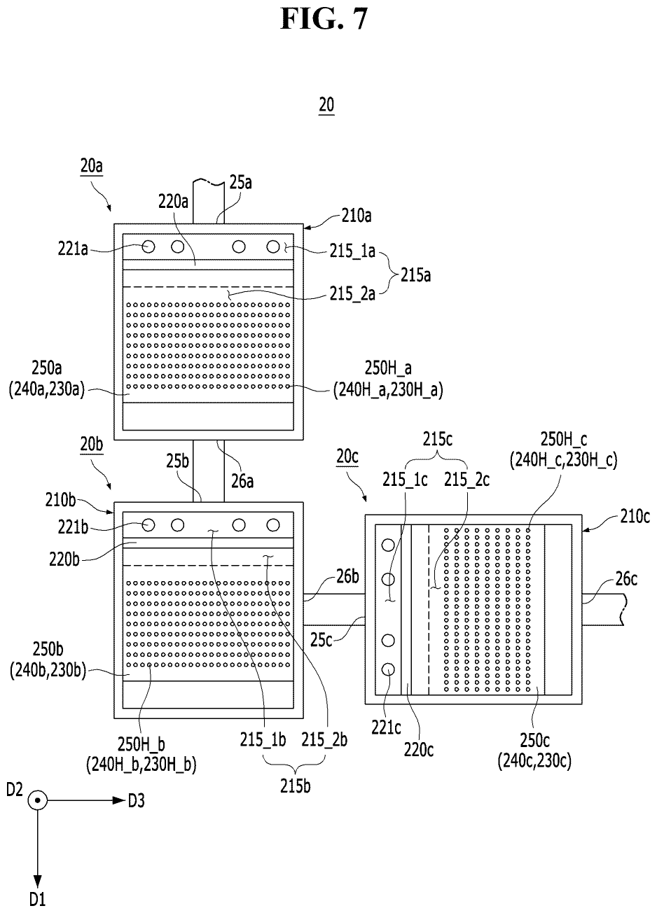

For reference, FIGS. 5, 6, 10, 11, and 12 may each be exemplary cross-sectional views of a scrubbing apparatus according to some embodiments, and FIGS. 7 to 9 may each be plan views of a scrubbing apparatus according to some embodiments.

First, referring to FIG. 5, the scrubbing apparatus according to some embodiments of the present invention may further include a third scrubber 20c.

The first to third scrubber 20a, 20b, and 20c may be arranged in one direction. For example, the first to third 20a, 20b, and 20c may be arranged in series along the first direction D1.

The third scrubber 20c may include a third chamber 210c, a third separating wall 220c, a third-1 scrubbing plate 230c, a third-2 scrubbing plate 240c, a third-3 scrubbing plate 250c, a third spray nozzle 221c, a third solution supply nozzle 223c, a third-1 scrubbing hole 230H_c, a third-2 scrubbing hole 240H_c, a third-3 scrubbing hole 250H_c, a third-1 scrubbing wall 235c, a third-2 scrubbing wall 245c, a third-3 scrubbing wall 255c, and a third demister 260c.

Descriptions of the third chamber 210c, the third separating wall 220c, the third-1 scrubbing plate 230c, the third-2 scrubbing plate 240c, the third-3 scrubbing plate 250c, the third spray nozzle 221c, the third solution supply nozzle 223c, the third-1 scrubbing hole 230H_c, the third-2 scrubbing hole 240H_c, the third-3 scrubbing hole 250H_c, the third-1 scrubbing wall 235c, the third-2 scrubbing wall 245c, the third-3 scrubbing wall 255c, and the third demister 260c may be the same as those described for the first scrubber 20a, and are therefore omitted.

In some embodiments, the third scrubber 20c may include a third gas inlet port 25c and a third gas outlet port 26c. The gas that has been primarily and secondarily scrubbed by the first scrubber 20a and the second scrubber 20b, respectively, may be supplied to the third scrubber 20c. The gas may be supplied to the third scrubber 20c through the third gas inlet port 25c. The third gas inlet port 25c may be formed at the same vertical level as the second gas outlet port 26b. For example, based on the bottom surface of the third chamber 210c, the height of the second gas outlet port 26b and the height of the third gas inlet port 25c may be the same, however, the technical scope of the present invention is not limited thereto.

The third impurity contained in the gas may be dissolved in a third scrubbing solution inside the third chamber 210c. The third scrubbing solution may include a third-1 scrubbing solution 225c and a third-2 scrubbing solution. The third chamber 210c may define a third scrubbing space 215c. The third scrubbing space 215c may be a space in which a third scrubbing process is performed, in which the third impurity contained in the gas is tertiarily dissolved in the third scrubbing solution.

In some embodiments, the third scrubbing space 215c may include a third-1 sub-space 215_1c and a third-2 sub-space 215_2c. The third-1 sub-space 215_1c and the third-2 sub-space 215_2c may be divided by the third separating wall 220c.

The third-1 scrubbing process may be performed in the third-1 sub-space 215_1c. The third-2 scrubbing process may be performed in the third-2 sub-space 215_2c. The third-1 scrubbing process may be a process in which a portion of the third impurity is dissolved in the third-1 scrubbing solution 225c. The third-2 scrubbing process may be a process in which another portion of the third impurity is dissolved in the third-2 scrubbing solution 227c. The third-1 scrubbing processes and third-2 scrubbing process may together constitute the third scrubbing process. The third-1 scrubbing solution 225c may be the same as or different from the third-2 scrubbing solution 227c.

The third solution supply nozzle 223c may be disposed in the third chamber 210c. The third solution supply nozzle 223c may supply the third-2 scrubbing solution 227c to the third-2 sub-space 215_2c. The third-2 scrubbing solution 227c may be discharged to the upper surface of the third-3 scrubbing plate 250c. The third-2 scrubbing solution 227c may be, for example, water. However, the technical scope of the present invention is not limited thereto.

The scrubbing solution 275c in which the third impurity is dissolved may be stored in the third solution storage tank 270c. For example, the scrubbing solution 275c in which the third impurity is dissolved may be a solution in which the third impurity is dissolved in the third-1 scrubbing solution 225c and the third-2 scrubbing solution 227c. For example, the third impurity may be a hydrophilic gas.

In some embodiments, the concentration of the third impurity stored in the third solution storage tank 270c is lower than the concentration of the second impurity stored in the second solution storage tank 270b. This may be because the amount of impurities scrubbed by the second scrubber 20b is greater than the amount of impurities scrubbed by the third scrubber 20c.

In some embodiments, the third-1 scrubbing solution 225c may be supplied to the third-1 sub-space 215_1c through the third spray nozzle 221c.

The third-1 scrubbing solution 225c may be supplied from the upper part to the lower part of the third-1 sub-space 215_1c, and while the gas flows from the upper part to the lower part of the third-1 sub-space 215_1c, at least a portion of the impurities contained in the gas may be dissolved in the third-1 scrubbing solution 225c. In some embodiments, the thrid-1 scrubbing solution 225c may include water. However, the technical scope of the present invention is not limited thereto.

In some embodiments, a negative pressure may be provided to the third scrubbing space 215c through the third gas inlet port 25c and the third gas outlet port 26c. The third-1 scrubbing process and the third-2 scrubbing process may be performed by utilizing the difference between the pressure at the third gas inlet port 25c and the pressure at the third gas outlet port 26c.

In this manner, when the scrubbing apparatus 20 of the present invention is used, impurities may be tertiarily scrubbed using three scrubbers. Accordingly, a scrubbing apparatus 20 with improved scrubbing efficiency and spatial efficiency may be provided.

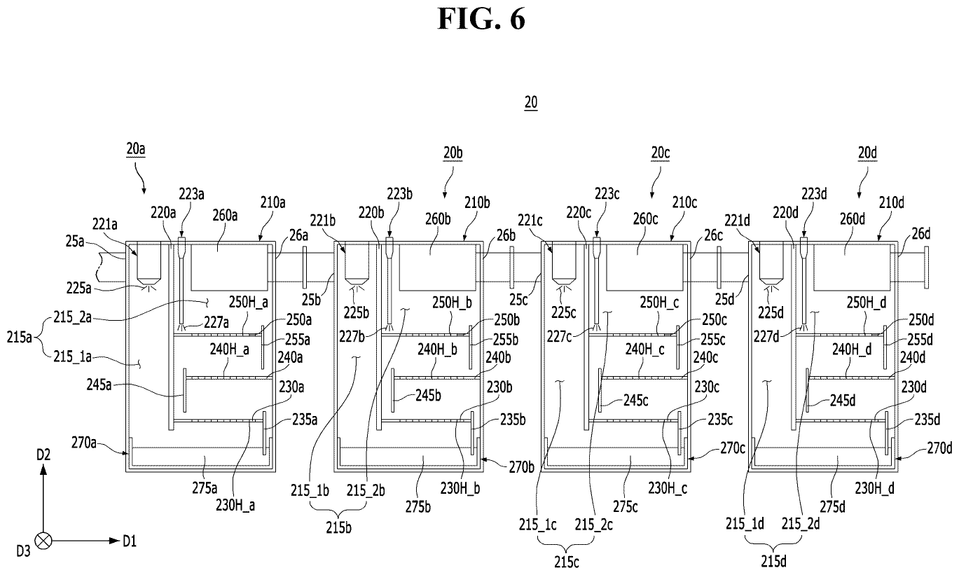

Referring to FIG. 6, the scrubbing apparatus according to some embodiments of the present invention may further include a third scrubber 20c and a fourth scrubber 20d.

The first to fourth scrubbers 20a, 20b, 20c, and 20d may be arranged in one direction. For example, The first to fourth scrubbers 20a, 20b, 20c, and 20d may be arranged in series along the first direction D1.

The third scrubber 20c may be the same as that described with reference to FIG. 5, and thus, a detailed description thereof will be omitted.

The fourth scrubber 20d may include a fourth chamber 210d, a fourth separating wall 220d, a fourth-1 scrubbing plate 230d, a fourth-2 scrubbing plate 240d, a fourth-3 scrubbing plate 250d, a fourth spray nozzle 221d, a fourth solution supply nozzle 223d, a fourth-1 scrubbing hole 230H_d, a fourth-2 scrubbing hole 240H_d, a fourth-3 scrubbing hole 250H_d, a fourth-1 scrubbing wall 235d, a fourth-2 scrubbing wall 245d, a fourth-3 scrubbing wall 255d, and a fourth demister 260d.

The description of the fourth scrubber 20d may be substantially the same as the description of the third scrubber 20c provided with reference to FIG. 5.

For example, the gas that has been tertiarily scrubbed may be supplied to the fourth chamber 210d. In the fourth scrubbing space 215d, a fourth impurity contained in the gas may be scrubbed. The fourth scrubbing space 215d includes a fourth-1 sub-space 215_1d and a fourth-2 sub-space 215_2d. A portion of the fourth impurity may be scrubbed in the fourth-1 sub-space 215_1d, and another portion of the fourth impurity may be scrubbed in the fourth-2 sub-space 215_2d.

In the fourth-1 sub-space 215_1d, a portion of the fourth impurity is dissolved in the fourth-1 scrubbing solution 225d. In the fourth-2 sub-space 215_2d, another portion of the fourth impurity is dissolved in the fourth-2 scrubbing solution 227d.

A scrubbing solution 275d in which the fourth impurity is dissolved may be stored in the fourth solution storage tank 270d. For example, the scrubbing solution 275d in which the fourth impurity is dissolved may be a solution in which the fourth impurity is dissolved in the fourth-1 scrubbing solution 225d and the fourth-2 scrubbing solution 227d. For example, the fourth impurity may be a hydrophilic gas.

In some embodiments, the concentration of the fourth impurity stored in the fourth solution storage tank 270d is lower than the concentration of the third impurity stored in the third solution storage tank 270c. This may be because the amount of impurities scrubbed by the third scrubber 20c is greater than the amount of impurities scrubbed by the fourth scrubber 20d.

In some embodiments, a negative pressure may be provided to the fourth scrubbing space 215d through the fourth gas inlet port 25d and the fourth gas outlet port 26d. The fourth-1 scrubbing process and the fourth-2 scrubbing process may be performed using a pressure difference between the pressure at the fourth gas inlet port 25d and the pressure at the fourth gas outlet port 26d.

In this manner, when the scrubbing apparatus 20 of the present invention is used, impurities may be scrubbed quaternarily using four scrubbers. Accordingly, a scrubbing apparatus 20 with improved scrubbing efficiency and spatial efficiency may be provided.

Referring to FIG. 7, the scrubbing apparatus according to some embodiment of the present invention may further include a third scrubber 20c. The first to third scrubbers 20a, 20b, and 20c may be arranged in an L-shape in plan view.

First, the first scrubber 20a and the second scrubber 20b may be arranged in the first direction D1, and the second scrubber 20b and the third scrubber 20c may be arranged in the third direction D3.

In the second scrubber 20b, the side wall on which the second gas inlet port 25b is formed and the side wall on which the second gas outlet port 26b is formed may intersect each other. For example, the side wall on which the second gas inlet port 25b is formed may extend in the third direction D3, while the side wall on which the second gas outlet port 26b is formed may extend in the first direction D1.

In addition, the extension direction of the second-1 sub-space 215_1b and the extension direction of the third-1 sub-space 215_1c may intersect each other. For example, the second-1 sub-space 215_1b may extend in the third direction D3, and the third-1 sub-space 215_1c may extend in the first direction D1.

When the scrubbing apparatus 20 according to some embodiments of the present invention is used, three scrubbers may be arranged in an L-shape or a reversed-L-shape in plan view. Accordingly, the scrubbing apparatus 20 with improved spatial efficiency may be provided.

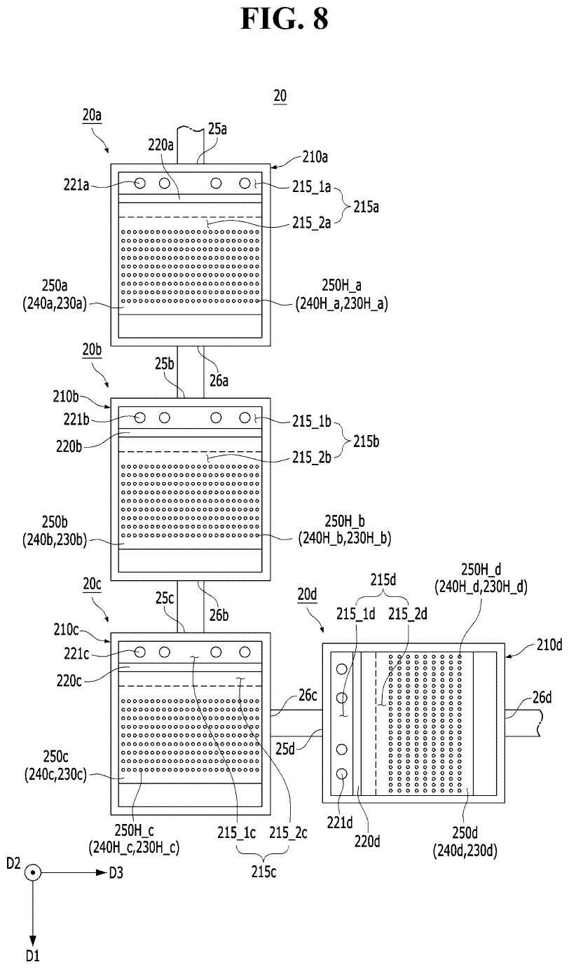

Referring to FIG. 8, the scrubbing apparatus according to some embodiment of the present invention may further include a third scrubber 20c and a fourth scrubber 20d. The first to fourth scrubbers 20a, 20b, 20c, and 20d may be arranged in an L-shape or a reversed-L-shape in plan view.

First, the first scrubber 20a, the second scrubber 20b, and the third scrubber 20c may be arranged in the first direction D1, and the third scrubber 20c and the fourth scrubber 20d may be arranged in the third direction D3.

That is, the side wall on which the third gas inlet port 25c is formed and the side wall on which the third gas outlet port 26c is formed in the third scrubber 20c may intersect each other. For example, the side wall on which the third gas inlet port 25c may be formed may extend in the third direction D3, while the side wall on which the third gas outlet port 26c is formed may extend in the first direction D1.

In addition, the extension direction of the third-1 sub-space 215_1c and the extension direction of the fourth-1 sub-space 215_1d may intersect each other. For example, the third-1 sub-space 215_1c may extend in the third direction D3, and the fourth-1 sub-space 215_1d may extend in the first direction D1.

Contrary to what is illustrated, the first scrubber 20a and the second scrubber 20b may be arranged in the first direction D1, and the second scrubber 20b, the third scrubber 20c, and the fourth scrubber 20d may be arranged in the third direction D3. In this case, the side wall on which the second gas inlet port 25b is formed and the side wall on which the second gas outlet port 26b is formed may intersect each other in the second scrubber 20b. For example, the side wall on which the second gas inlet port 25b is formed may extend in the third direction D3, while the side wall on which the second gas outlet port 26b is formed may extend in the first direction D1.

When the scrubbing apparatus 20 according to some embodiments of the present invention is used, four scrubbers may be arranged in an L-shape or a reversed-L-shape in plan view. Accordingly, the scrubbing apparatus 20 with improved spatial efficiency may be provided.

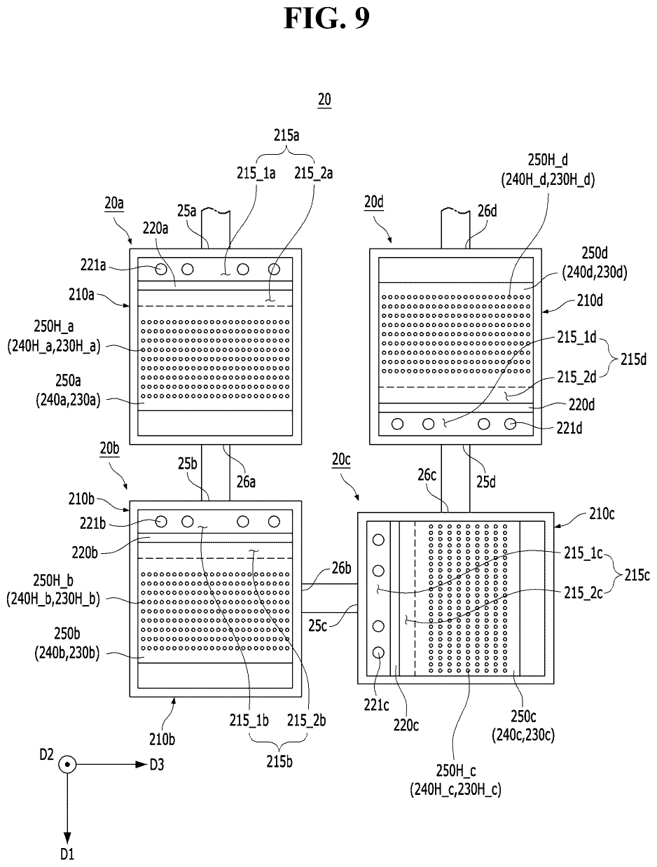

Referring to FIG. 9, the scrubbing apparatus may further include a third scrubber 20c and a fourth scrubber 20d. The first to fourth scrubbers 20a, 20b, 20c, and 20d may be arranged in a U-shape or a grid pattern.

For example, The first scrubber 20a and the second scrubber 20d may be arranged in the first direction D1, the second scrubber 20b and the third scrubber 20c may be arranged in the third direction D3, the fourth scrubber 20d and the third scrubber 20c may be arranged in the first direction D1, and the first scrubber 20a and the fourth scrubber 20d may be arranged in the third direction D3.

The first scrubber 20a and the third scrubber 20c may be spaced apart from each other in a diagonal direction, and the second scrubber 20b and the fourth scrubber 20d may be spaced apart from each other in a diagonal direction.

In some embodiments, the second-1 sub-space 215_1b may extend in the third direction D3. The third-1 sub-space 215_1c may extend in the first direction D1. The fourth-1 sub-space 215_1d may extend in the third direction D3. That is, the extension direction of the second sub-space 215_1b and the extension direction of the third sub-space 215_1c may intersect each other, and the extension direction of the third sub-space 215_1c and the extension direction of the fourth sub-space 215_1d may also intersect each other.

When the scrubbing apparatus 20 according to some embodiments of the present invention is used, four scrubbers may be arranged in a U-shape or a grid pattern. Accordingly, the scrubbing apparatus 20 with improved spatial efficiency may be provided.

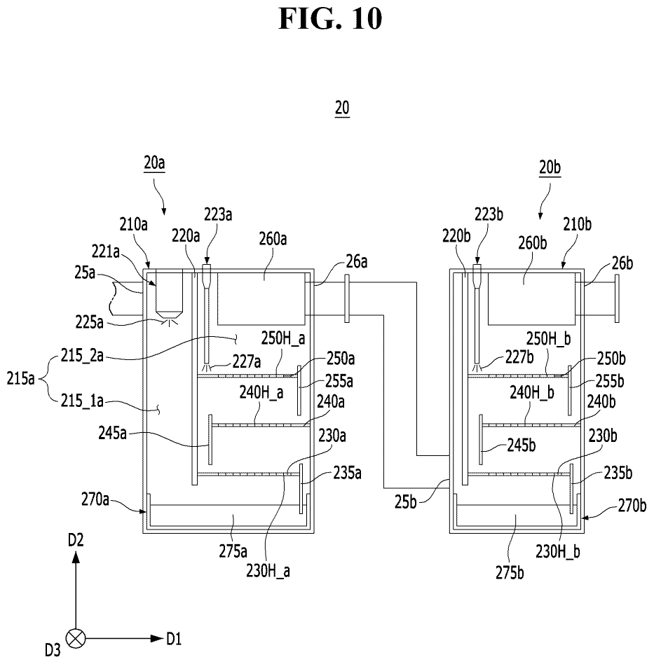

Referring to FIG. 10, the scrubbing apparatus 20 according to some embodiments may not include the second-1 sub-space (215_1b of FIG. 3). The second scrubbing space 215b may include only the second-2 sub-space.

In this case, the gas that has passed through the first scrubber 20a may be introduced into the lower part of the second scrubber 20b. That is, the vertical level of the first gas outlet port 26a may be different from the vertical level of the second gas inlet port 25b. Based on the bottom surface of the first chamber 210a, the height of the first gas outlet port 26a may be greater than the height of the second gas inlet port 25b.

Since the second scrubbing space 215b does not include the second-1 sub-space 215_1b, space efficiency can be improved.

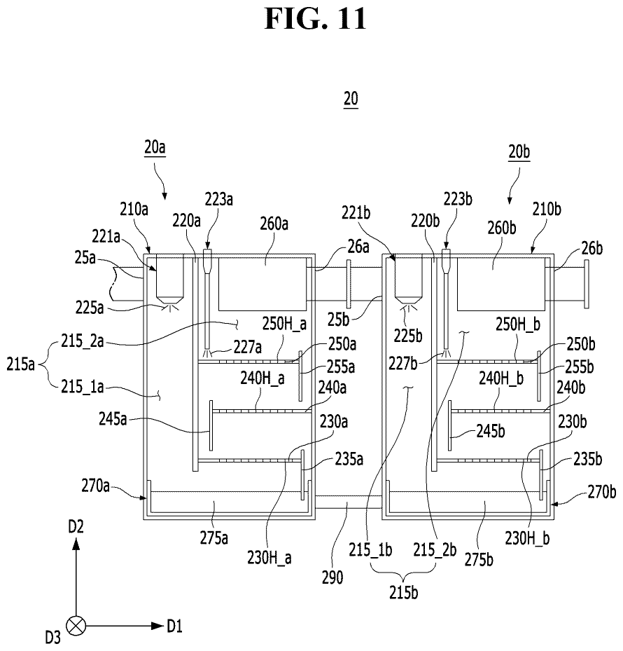

Referring to FIG. 11, in the scrubbing apparatus 20 according to some embodiments, the first solution storage tank 270a and the second solution storage tank 270b may be connected to each other through a tank connection pipe 290. Accordingly, the scrubbing solution 275a, in which the first impurity is dissolved, and the scrubbing solution 275b, in which the second impurity is dissolved, may be mixed with each other. Since the scrubbing solution 275a, in which the first impurity is dissolved, and the scrubbing solution 275b, in which the second impurity is dissolved, are mixed, the concentration of impurities in the solution may be adjusted.

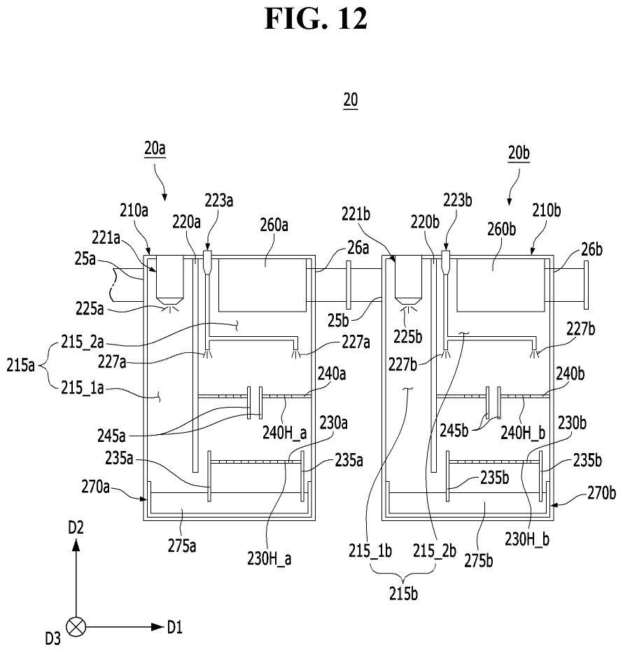

Referring to FIG. 12, the first scrubber 20a and the second scrubber 20b according to some embodiment may each include two scrubbing plates. That is, the first scrubber 20a may include the first-1 scrubbing plate 230a and the second-2 scrubbing plate 240a. The second scrubber 20b may include the second-1 scrubbing plate 230b and the second-2 scrubbing plate 240b.

In this case, the shape of the first-1 scrubbing plate 230a may be different from the shape of the second-1 scrubbing plate 240a. Likewise, the shape of the first-1 scrubbing plate 230b may be different from the shape of the second-1 scrubbing plate 240b. The first-1 scrubbing plate 230a may be substantially the same as the second-1 scrubbing plate 230b, and the first-2 scrubbing plate 240a may be substantially the same as the second-2 scrubbing plate 240b. Therefore, only the first-1 scrubbing plate 230a and the first-2 scrubbing plate 240a will be described below.

In some embodiments, both ends of the first-1 scrubbing plate 230a may be spaced apart from the first separating wall 220a and from the inner side wall of the first scrubber 20a facing the first separating wall 220a, respectively. Specifically, the first-1 scrubbing plate 230a may not be connected in contact with either the first separating wall 220a or the inner side wall of the first scrubber 20a facing the first separating wall 220a.

A pair of first-1 scrubbing walls 235a may be disposed at both ends of the first-1 scrubbing plate 230a. One of the pair of first-1 scrubbing walls 235a may be interposed between the first-1 scrubbing plate 230a and the first-1 separating wall 220a. The other of the pair of first-1 scrubbing walls 235a may be interposed between the first-1 scrubbing plate 230a and the inner side wall of the first scrubber 20a that faces the first-1 separating wall 220a.

The space between the first-1 scrubbing wall 235a and the first separating wall 220a, and the space between the first-1 scrubbing wall 235a and the inner side wall of the first scrubber 20a facing the first separating wall 220a, may each be a space through which the first-2 scrubbing solution 227a flows downward (e.g., in the second direction D2).

Both ends of the first-2 scrubbing plate 240a may be connected in contact with the first separating wall 220a and the inner side wall of the first scrubber 20a facing the first separating wall 220a, respectively. The first-2 scrubbing plate 240a may have a structure in which a central portion is open. That is, the first-2 scrubbing plate 240a may include an opening formed in the central portion thereof, which may extend in the third direction D3. The opening may expose at least a portion of the upper surface of the first-1 scrubbing plate 230a. In other words, the opening may overlap with at least a portion of the upper surface of the first-1 scrubbing plate 230a in the second direction D2.

A pair of first-2 scrubbing walls 245a may each be disposed at the central portion of the first-2 scrubbing plate 240a. The pair of first-2 scrubbing walls 245a may each be disposed within the opening.

The pair of first-2 scrubbing walls 245a may be spaced apart from each other in the first direction D1. A space between the pair of first-2 scrubbing walls 245a may be a space through which the first-2 scrubbing solution 227a flows downward (e.g., in the second direction D2).

In some embodiments, the first-2 scrubbing solution 227a may be discharged at both ends of the first-2 scrubbing plate 240a. For example, the first-2 scrubbing solution 227a may be discharged to a region of the first-2 scrubbing plate 240a adjacent to the first separating wall 220a and to a region of the first-2 scrubbing plate 240a adjacent to the inner side wall of the first scrubber 20a, respectively.

The first-2 scrubbing solution 227a discharged onto the upper surface of the first-2 scrubbing plate 240a may flow toward a central portion of the first-2 scrubbing plate 240a. The first-2 scrubbing solution 227a discharged onto the upper surface of the first-2 scrubbing plate 240a may flow into the opening.

While the first-2 scrubbing solution 227a flows toward the central portion of the first-2 scrubbing plate 240a, impurities may be dissolved in the first-2 scrubbing solution 227a. The first-2 scrubbing solution 227a may be discharged over the first-2 scrubbing wall 245a onto the upper surface of the first-1 scrubbing plate 230a. The first-2 scrubbing solution 227a discharged onto the upper surface of the first-1 scrubbing plate 230a may flow toward both ends of the first-1 scrubbing plate 230a.

In FIG. 12, the first scrubber 20a and the second scrubber 20b are illustrated as each including two scrubbing plates, however, the technical scope of the present invention is not limited thereto. If the first scrubber 20a includes three scrubbing plates, the shape of the first-3 scrubbing plate may be the same as the shape of the first-1 scrubbing plate 230a. The first-3 scrubbing plate may be disposed on the first-2 scrubbing plate 240a.

If the first scrubber 20a includes four scrubbing plates, the shape of the first-3 scrubbing plate may be the same as the shape of the first-1 scrubbing plate 230a, and the shape of the first-4 scrubbing plate may be the same as the shape of the first-2 scrubbing plate 240a. The first-3 scrubbing plate may be disposed on the first-2 scrubbing plate 240a, and the first-4 scrubbing plate may be disposed on the first-3 scrubbing plate.

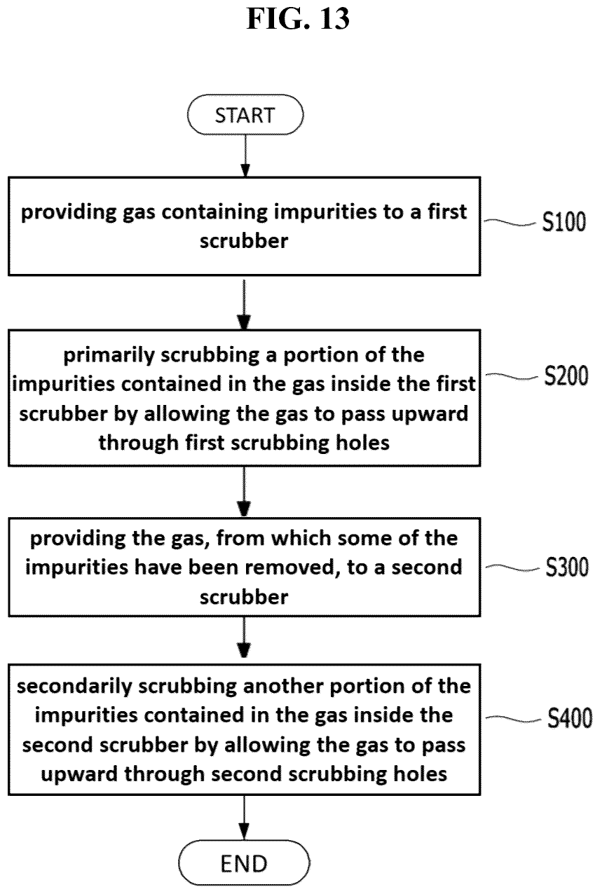

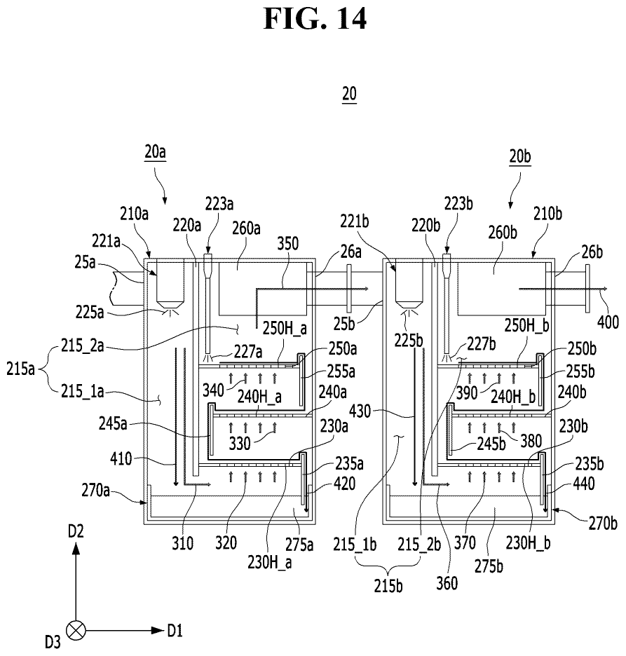

Hereinafter, an operating method of the scrubbing apparatus according to some embodiments of the present invention will be described with reference to FIGS. 13 and 14. For reference, FIG. 13 may be an exemplary flowchart for illustrating an operating method of a scrubbing apparatus according to some embodiments of the present invention.

FIGS. 13 and 14 are drawings for explaining an operating method of a scrubbing apparatus according to some embodiments of the present invention.

First, referring to FIG. 13, an operating method of the scrubbing apparatus according to some embodiments of the present invention may include providing gas containing impurities to a first scrubber S100, primarily scrubbing a portion of the impurities contained in the gas inside the first scrubber by allowing the gas to pass upward through first scrubbing holes S200, providing the gas, from which some of the impurities have been removed, to a second scrubber S300, and secondarily scrubbing another portion of the impurities contained in the gas inside the second scrubber by allowing the gas to pass upward through second scrubbing holes S400.

Specifically, referring to FIGS. 1 and 14, gas G containing impurities may be supplied from the process chamber 10 to the first scrubber 20a. The gas G containing impurities may be introduced into the first scrubber 20a through the first gas inlet port 25a by passing through the first pipe 11 (see reference numeral 310).

The gas G containing impurities may be introduced into the first-1 sub-space 215_1a. For example, the gas G containing impurities may move to the lower part of the first-1 sub-space 215_1a (see reference numeral 310).

In some embodiments, the first-1 scrubbing process may be performed in the first-1 sub-space 215_1a.

Specifically, the first-1 scrubbing solution 225a may be supplied into the first-1 sub-space 215_1a through the first spray nozzle 221a (see reference numeral 410). The first-1 scrubbing solution 225a may be water, although the technical scope of the present invention is not limited thereto.

In FIG. 14, the first-1 scrubbing solution 225a is illustrated as being sprayed vertically in the second direction D2, however, the technical scope of the present invention is not limited thereto.

The first spray nozzle 221a may supply the first-1 scrubbing solution 225a having fine particles. As the gas G containing impurities moves to the lower part of the first-1 sub-space 215_1a, the first impurity contained in the gas G may be dissolved in the first-1 scrubbing solution 225a. The gas may be supplied to the first-2 sub-space 215_2a (see reference numeral 310). the first-2 scrubbing process may be performed in the first-2 sub-space 215_2a.

While the first-2 scrubbing process is being performed, the first solution supply nozzle 223a may supply the first-2 scrubbing solution 227a onto the upper surface of the first-3 scrubbing plate 250a. The initially supplied first-2 scrubbing solution 227a may flow downward through the first-3 scrubbing holes 250H_a, the first-2 scrubbing holes 240H_a, and the first-1 scrubbing holes 230H_a. That is, in the initial state, the first-2 scrubbing solution 227a may flow downward through the scrubbing holes 250H_a, 240H_a, and 230H_a.

While the first-2 scrubbing process is being performed, the gas G may ascend in the second direction D2. The gas G may ascend in the second direction D2 by passing through the first-1 scrubbing holes 230H_a.

Specifically, referring to FIG. 4, the gas G may ascend through the first-1 scrubbing holes 230H_a. As the gas G ascends in the second direction D2, the bubbles BBL may be formed in the first-2 scrubbing solution 227a. At the contact area between the bubbles BBL and the first-2 scrubbing solution 227a, impurities contained in the gas G may be dissolved in the first-2 scrubbing solution 227a.

While the first-2 scrubbing process is being performed, the first-2 scrubbing solution 227a does not flow downward through the scrubbing holes 250H_a, 240H_a, and 230H_a (see reference numeral 420). This may be due to the pressure of the gas G rising through the scrubbing holes 250H_a, 240H_a, and 230H_a.

While the first-2 scrubbing process is being performed, the first-2 scrubbing solution 227a may flow on the upper surface of the first-3 scrubbing plate 250a toward the first-3 scrubbing wall 255a, and may flow over the first-3 scrubbing wall 255a onto the upper surface of the first-2 scrubbing plate 240a (see reference numeral 420). In addition, the first-2 scrubbing solution 227a may flow on the upper surface of the first-2 scrubbing plate 240a toward the first-2 scrubbing wall 245a, and may flow over the first-2 scrubbing wall 245a onto the upper surface of the first-1 scrubbing plate 230a (see reference numeral 420). Furthermore, the first-2 scrubbing solution 227a may flow on the upper surface of the first-1 scrubbing plate 230a toward the first-1 scrubbing wall 235a, and may flow over the first-1 scrubbing wall 235a to the lower part of the first chamber 210a (see reference numeral 420).

While the first-2 scrubbing solution 227a flows in the above-described direction, the gas G may ascend in the second direction D2 through the scrubbing holes 250H_a, 240H_a, and 230H_a. As the gas G passes through the scrubbing holes 250H_a, 240H_a, and 230H_a, the bubbles may be formed in the first-2 scrubbing solution 227a.

Specifically, the gas G may ascend through the first-1 scrubbing holes 230H_a (see reference numeral 320). Subsequently, the gas G may ascend through the first-2 scrubbing holes 240H_a (see reference numeral 330). Then, the gas G may ascend through the first-3 scrubbing holes 250H_a (see reference numeral 340).

As the gas G ascends through the scrubbing holes 250H_a, 240H_a, and 230H_a, impurities contained in the gas may be dissolved in the first-2 scrubbing solution 227a.

Subsequently, the gas G′, from which some impurities have been removed, may be discharged to the outside of the first chamber 210a through the first demister 260a (see reference numeral 350). The gas G′ discharged through the first gas outlet port 26a may be supplied to the second chamber 210b (see reference numeral 350).

In the second chamber 210b, impurities contained in the gas may be secondarily scrubbed. For example, the gas supplied to the second chamber 210b may be introduced into the second-1 sub-space 215_1b and may flow from the upper part to the lower part of the second-1 sub-space 215_1b (see reference numeral 360). The second-1 scrubbing process may be performed in the second-1 sub-space 215_1b.

Specifically, the second-1 scrubbing solution 225b may be supplied into the second-1 sub-space 215_1b through the second spray nozzle 221b (see reference numeral 430). The second-1 scrubbing solution 225b may be water, although the technical scope of the present invention is not limited thereto.

The gas may be supplied to the second-2 sub-space 215_2b (see reference numeral 360). The second-2 scrubbing process may be performed in the second-2 sub-space 215_2b.

While the second-2 scrubbing process is being performed, the second solution supply nozzle 223b may supply the second-2 scrubbing solution 227b onto the upper surface of the second-3 scrubbing plate 250b. The initially supplied second-2 scrubbing solution 227b may flow downward through the second-3 scrubbing holes 250H_b, the second-2 scrubbing holes 240H_b, and the second-1 scrubbing holes 230H_b. That is, in the initial state, the second-2 scrubbing solution 227b may flow downward through the scrubbing holes 250H_b, 240H_b, and 230H_b.

While the second-2 scrubbing process is being performed, the gas G may ascend in the second direction D2. The gas G may ascend in the second direction D2 by passing through the second-1 scrubbing holes 230H_b.

While the second-2 scrubbing process is being performed, the second-2 scrubbing solution 227b does not flow downward through the scrubbing holes 250H_b, 240H_b, and 230H_b (see reference numeral 440). This may be due to the pressure of the gas G ascending through the scrubbing holes 250H_b, 240H_b, and 230H_b.

While the second-2 scrubbing process is being performed, the second-2 scrubbing solution 227b may flow on the upper surface of the second-3 scrubbing plate 250b toward the second-3 scrubbing wall 255b, and may flow over the second-3 scrubbing wall 255b onto the upper surface of the second-2 scrubbing plate 240b (see reference numeral 440). In addition, the second-2 scrubbing solution 227b may flow on the upper surface of the second-2 scrubbing plate 240b toward the second-2 scrubbing wall 245b, and may flow over the second-2 scrubbing wall 245b onto the upper surface of the second-1 scrubbing plate 230b (see reference numeral 440). Furthermore, the second-2 scrubbing solution 227b may flow on the upper surface of the second-1 scrubbing plate 230b toward the second-1 scrubbing wall 235b, and may flow over the second-1 scrubbing wall 235b to the lower part of the second chamber 210b (see reference numeral 440).

While the second-2 scrubbing solution 227b flows in the above-described direction, the gas G may ascend in the second direction D2 through the scrubbing holes 250H_b, 240H_b, and 230H_b. As the gas G passes through the scrubbing holes 250H_b, 240H_b, and 230H_b, bubbles may be formed in the second-2 scrubbing solution 227b.

Specifically, the gas G may ascend through the second-1 scrubbing holes 230H_b (see reference numeral 370). Subsequently, the gas G may ascend through the second-2 scrubbing holes 240H_b (see reference numeral 380). Then, the gas G may ascend through the second-3 scrubbing holes 250H_b (see reference numeral 390).

As the gas G ascends through the scrubbing holes 250H_b, 240H_b, and 230H_b, impurities contained in the gas may be dissolved in the second-2 scrubbing solution 227b.

Subsequently, the gas G′′ from which the impurities have been removed may be discharged to the outside of the second chamber 210b through the second demister 260b (see reference numeral 400).

As such, by using the scrubbing apparatus 20 of the present invention, impurities contained in the gas can be primarily scrubbed using the first scrubber 20a and secondarily scrubbed using the second scrubber 20b. Accordingly, scrubbing efficiency can be improved, and spatial efficiency can also be enhanced due to the inclusion of a plurality of scrubbers.

Although the embodiments of the present invention have been described with reference to the attached drawings, the present invention is not limited to the embodiments described above, but can be manufactured in various different forms, and a person having ordinary skill in the art to which the present invention pertains will understand that the present invention can be implemented in other specific forms without changing the technical scope or essential features of the present invention. Therefore, it should be understood that the embodiments described above are exemplary in all respects and not restrictive.

1. A scrubbing apparatus comprising:
a first scrubber for performing primary scrubbing of gas; and
a second scrubber connected to the first scrubber, for performing secondary scrubbing of the gas that has passed through the first scrubber,
wherein the first scrubber comprising:
a first chamber for defining a first scrubbing space for scrubbing a portion of impurities contained in the gas;
a first scrubbing plate disposed in the first chamber, at least a portion of the first scrubbing plate being fixed to an inner side wall of the first chamber;
a first solution supply nozzle for supplying a first scrubbing solution onto an upper surface of the first scrubbing plate; and
a plurality of first scrubbing holes penetrating the first scrubbing plate,
the second scrubber comprising:
a second chamber for defining a second scrubbing space for scrubbing another portion of impurities contained the gas;
a second scrubbing plate disposed in the second chamber, at least a portion of the second scrubbing plate being fixed to an inner side wall of the second chamber;
a second solution supply nozzle for supplying a second scrubbing solution onto an upper surface of the second scrubbing plate; and
a plurality of second scrubbing holes penetrating the second scrubbing plate.

2. The scrubbing apparatus of claim 1, wherein a portion of the impurities contained in the gas is dissolved in the first scrubbing solution by ascending through the plurality of first scrubbing holes within the first chamber, and
wherein another portion of the impurities contained in the gas is dissolved in the second scrubbing solution by ascending through the plurality of second scrubbing holes within the second chamber.

3. The scrubbing apparatus of claim 1, further comprising:
a third scrubber connected to the second scrubber and scrubbing the gas that has passed through the second chamber,
wherein the third scrubber comprises:
a third chamber defining a third scrubbing space in which another portion of the impurities contained in the gas is scrubbed;
a third scrubbing plate disposed in the third chamber and at least partially fixed to an inner side wall of the third chamber;
a third solution supply nozzle that supplies a third scrubbing solution onto an upper surface of the third scrubbing plate; and
a plurality of third scrubbing holes penetrating the third scrubbing plate,
wherein the first scrubber, the second scrubber, and the third scrubber are arranged in series along the same direction.

4. The scrubbing apparatus of claim 3, further comprising:
a fourth scrubber connected to the third scrubber, and scrubbing the gas that has passed through the third scrubber,
wherein the first to fourth scrubbers are arranged in series along the same direction, or in an L-shaped configuration.

5. The scrubbing apparatus of claim 1,, further comprising:
a third scrubber connected to the second scrubber and scrubbing the gas that has passed through the second chamber,
wherein the third scrubber comprises:
a third chamber defining a third scrubbing space in which another portion of the impurities contained in the gas is scrubbed;
a third scrubbing plate disposed in the third chamber and at least partially fixed to an inner side wall of the third chamber;
a third solution supply nozzle that supplies a third scrubbing solution onto an upper surface of the third scrubbing plate; and
a plurality of third scrubbing holes penetrating the third scrubbing plate,
wherein the first scrubber, the second scrubber, and the third scrubber are arranged in an L-shaped configuration.

6. The scrubbing apparatus of claim 1, wherein the first scrubber comprises a first gas inlet port through which the gas is introduced into the first chamber, and a first gas outlet port through which the gas is discharged from the first chamber, and
wherein the first gas inlet port is formed on one side wall of the first chamber, and the first gas outlet port is formed on an opposite side wall facing the one side wall.

7. The scrubbing apparatus of claim 6, wherein the first gas inlet port and the first gas outlet port are formed at the same vertical level.

8. The scrubbing apparatus of claim 6, wherein the second scrubber comprises a second gas inlet port through which the gas is introduced into the second chamber, and
wherein the first gas outlet port and the second gas inlet port are connected to each other.

9. The scrubbing apparatus of claim 8, wherein a vertical lever of the first gas outlet port is higher than a vertical level of the second inlet port.

10. The scrubbing apparatus of claim 1, wherein the first scrubber comprises a first gas inlet port through which the gas is introduced into the first chamber, and a first gas outlet port through which the gas is discharged from the first chamber, and
wherein the first gas inlet port is formed on one side wall of the first chamber, and the first gas outlet port is formed on an opposite side wall intersecting the one side wall.

11. The scrubbing apparatus of claim 1, wherein the first scrubber comprises a first solution storage tank in which a first impurity among the impurities dissolved in the first scrubbing solution is stored, and
wherein the second scrubber comprises a second impurity among the impurities dissolved in the second scrubbing solution is stored.

12. The scrubbing apparatus of claim 11, wherein the concentration of the first impurity in the solution stored in the first solution storage tank is greater than the concentration of the second impurity in the solution stored in the second solution storage tank.
